(19) United States
(12) Patent Application Publication
(10) Pub. No.: US 2024/0407279 A1
(43) Pub. Date: Dec. 12, 2024

(54) CONTINUOUS FLOW SEED TREATER

(71) Applicant: AGINNOVATION LLC, Walnut Grove, CA (US)

(72) Inventor: Peter Marks, Lodi, CA (US)

(73) Assignee: AGINNOVATION LLC, Walnut Grove, CA (US)

(21) Appl. No.: 18/699,707

(22) PCT Filed: Nov. 2, 2022
(86) PCT No.: PCT/US22/79161

§ 371 Date: Apr. 9, 2024

Related U.S. Application Data
(60) Provisional application No. 63/274,594, filed on Nov. 2, 2021.

(51) Int. Cl. A01C 1/06

(52) U.S. Cl. CPC A01C 1/06

(57) ABSTRACT

A seed treatment flow path is configured to receive seed and seed treatment and discharge a combination of seed and seed treatment and a valve is configured for controlling seed movement in the flow path, wherein the valve includes a gate operably configured for opening and closing a gate opening. The seed treater also includes a liquid disperser for dispersing at least one liquid type of seed treatment in the flow path, wherein the liquid disperser is disposed downstream of the valve. The seed treater may also include a solid disperser for dispersing at least one solid type of seed treatment in the flow path, wherein the solid disperser is disposed downstream of the valve. The seed treater also includes an actuatable housing for actuating the seed treatment flow path for combinating the inputs into the flow path.

### CROSS-REFERENCE TO RELATED APPLICATIONS

This application claims priority under 35 U.S.C. § 119 to provisional application Ser. No. 63/274,594 filed Nov. 2, 2021, which is incorporated by reference in its entirety.

### FIELD OF THE DISCLOSURE

The present disclosure relates to a continuous flow seed treater. More particularly, but not exclusively, the present disclosure relates to a continuous flow seed treater for laboratory studies and testing.

### BACKGROUND

Commercial, large volume, seed treaters, whether vertical or otherwise, are known; however, such seed treaters do not provide an efficient, economical, and predictable research, testing, and studies platform to assess the viability and scalability of improving seed treatment processes and seed treatment slurries in view of the all the accompanying factors and considerations that impact the study and further development of improved seed treatment processes and seed treatment slurries using known systems and technologies.

Therefore, what is needed is a continuous flow seed treater that addresses the deficiencies in seed treatment processes and slurries along with the industry inhibitors for the continued development and study of seed treatment processes and slurries.

### SUMMARY

Therefore, it is a primary object, feature, or advantage of the present disclosure to improve over the state of the art.

It is a further object, feature, or advantage of the present disclosure to provide a continuous seed treater that may be configured to address at least one or more conditions for a seed, a seed treatment, an environment.

It is a still further object, feature, or advantage of the present disclosure to provide a seed treater that is configured to account for seed treatment loss and seed treatment residual in the tumbler.

Another object, feature, or advantage is to provide a seed treater that is configured with a non-planar gate that is electromechanically actuated through a gate opening to vary the seed flow rate through rate while maintaining continuous flow of seed.

Yet another object, feature, or advantage is to provide a seed treater that is configured with a controller for electromechanically controlling the seed flow rate, the liquid dispersion rate, and the solid dispersion rate based at least on one or more conditions.

In at least one exemplary aspect, a seed treater is disclosed. The seed treater includes, for example, a seed treatment flow path configured to receive seed and seed treatment and discharge a combination of seed with seed treatment and a valve in the seed treatment flow path for controlling seed movement, wherein the valve controls a throughput rate of seed introduced into the seed treatment flow path. The seed treater also includes a liquid disperser in the seed treatment flow path for dispersing at least one liquid type of seed treatment at a liquid dispersion rate, wherein the liquid disperser is disposed downstream of the valve. The seed treater may also include a solid disperser in the seed treatment flow path for dispersing at least one solid type of seed treatment at a solid dispersion rate, wherein the solid disperser is disposed downstream of the liquid disperser. The seed treater also includes an actuatable housing within the seed treatment flow path having a rate of operation and an adjustable orientation, wherein the actuatable housing is downstream of the valve for uniformly distributing the at least one liquid type of seed treatment, the at least one solid type of seed treatment, and seed for creating the combination of seed with seed treatment.

In at least one other exemplary aspect, a seed treatment method is disclosed. The seed treatment method includes, for example, such steps as providing a seed treatment flow path configured for receiving seed and seed treatment and discharging a combination of seed with seed treatment and a valve having a gate and gate opening and controlling a throughput rate of seed into the seed treatment flow path with a valve, wherein at least a portion of the gate is disposed within the gate opening in both open and closed positions. The method also includes dispersing at least one liquid type of seed treatment at a liquid dispersion rate into the seed treatment flow path downstream of the valve. The method may also include dispersing at least one solid type of seed treatment at a solid dispersion rate into the seed treatment flow path downstream of the valve and distributing the combination of seed, the at least one liquid type of seed treatment, and the at least one solid type of seed treatment at a rate of distribution within the seed treatment flow path.

In at least another aspect, a system for continuous treatment of seed is disclosed. The system includes, for example, a seed treatment flow path configured to receive seed and seed treatment and discharge a combination of seed with seed treatment, a valve operably configured to introduce a continuous flow of seed into the seed treatment flow path at a seed throughput rate, and a liquid disperser operably configured to introduce at least one liquid type of seed treatment into the seed treatment flow path at a liquid dispersion rate. The system may also include a solid disperser operably configured to introduce at least one solid type of seed treatment into the seed treatment flow path at a solid dispersion rate and a controller operably configured to control the seed throughput rate, the liquid dispersion rate, and the solid dispersion rate based at least on one or more conditions selected at least from a type of seed and a type of seed treatment.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated embodiments of the disclosure are described in detail below with reference to the attached drawing figures, which are incorporated by reference herein.

FIGS. 1A-1C are pictorial representations of various configurations a seed treatment flow path in accordance with exemplary aspects of the present disclosure.

FIG. 2 is a perspective view of a seed treater in accordance with an illustrative aspect of the present disclosure.

FIG. 3 is an end perspective view of a seed treater in accordance with an illustrative aspect of the present disclosure.

FIG. 4 is another end perspective view of a seed treater in accordance with an illustrative aspect of the present disclosure.

FIG. 5 is an elevation view of an end of a seed treater in accordance with an illustrative aspect of the present disclosure.

FIG. 6 is an end elevation view of a baffle of the seed treatment flow path in accordance with an illustrative aspect of the present disclosure.

FIG. 7 is an elevation view of a seed hopper, seed flow control system, and seed treatment flow path in accordance with an illustrative aspect of the present disclosure.

FIG. 8 is a perspective view of a seed flow control system and seed treatment flow path in accordance with an illustrative aspect of the present disclosure.

FIG. 9 is a perspective view of a seed flow control system, tumbling system, and seed treatment flow path in accordance with an illustrative aspect of the present disclosure.

FIG. 10 is a top perspective view of a cradle and drive system of the tumbling system in accordance with an illustrative aspect of the present disclosure.

FIG. 11 is an elevation view of a tilt control system of the tumbling system in accordance with an illustrative aspect of the present disclosure.

FIG. 12 is a perspective view of a tilt control system of the tumbling system in accordance with an illustrative aspect of the present disclosure.

FIG. 13 is a perspective view of a control component of the control system for the cradle and drive system in accordance with an illustrative aspect of the present disclosure.

FIG. 14 is a side perspective view of a tumbling system and a treater framework in accordance with an illustrative aspect of the present disclosure.

FIG. 15 is an elevation view of a pumping system of the liquid seed treater system in accordance with an illustrative aspect of the present disclosure.

FIG. 16 is a perspective view of a plumbing configuration of the liquid seed treater system in accordance with an illustrative aspect of the present disclosure.

FIG. 17 is another elevation view of a plumbing configuration of the liquid seed treater system in accordance with an illustrative aspect of the present disclosure.

FIG. 18 is a perspective view of a plumbing configuration and atomizing system in accordance with an illustrative aspect of the present disclosure.

FIG. 19 is a perspective view of a controller of the controller system in accordance with an illustrative aspect of the present disclosure.

FIG. 20 is a top perspective view of actuator system for the seed flow control system in accordance with an illustrative aspect of the present disclosure.

FIG. 21 is a top perspective view of a valve for the seed flow control system in accordance with an illustrative aspect of the present disclosure.

FIG. 22 is a top perspective view of a gate, gate surface, and gate opening for the valve for the seed flow control system in accordance with an illustrative aspect of the present disclosure.

FIG. 23 is another top perspective view of a gate, gate surface, and gate opening for the valve for the seed flow control system in accordance with an illustrative aspect of the present disclosure.

FIG. 24 is an end elevation view of a seed treater and seed flow control system in accordance with an illustrative aspect of the present disclosure.

FIG. 25 is a side elevation view of a seed treater and seed flow control system in accordance with an illustrative aspect of the present disclosure.

FIG. 26 is a top view of a tumbler in accordance with an illustrative aspect of the present disclosure.

FIG. 27 is an end view of a tumbler in accordance with an illustrative aspect of the present disclosure.

FIG. 28 is another end view of a tumbler in accordance with an illustrative aspect of the present disclosure.

FIG. 29 is another side view of a tumbler in accordance with an illustrative aspect of the present disclosure.

FIG. 30 is a front view of a controller and controller housing in accordance with an illustrative aspect of the present disclosure.

FIG. 31 is a side view of a controller and controller housing in accordance with an illustrative aspect of the present disclosure.

FIG. 32 is a top view of a treater framework in accordance with an illustrative aspect of the present disclosure.

FIG. 33 is a side view of a treater framework in accordance with an illustrative aspect of the present disclosure.

FIG. 34 is an end view of a treater framework in accordance with an illustrative aspect of the present disclosure.

FIG. 35 is another end view of a treater framework in accordance with an illustrative aspect of the present disclosure.

FIG. 36 is a front elevation view of a solid seed treater system and control system in accordance with an illustrative aspect of the present disclosure.

FIG. 37 is a side elevation view of a solid seed treater system and control system in accordance with an illustrative aspect of the present disclosure.

FIG. 38 is an end elevation view of a cradle and drive system and tilt controller system in accordance with an illustrative aspect of the present disclosure.

FIG. 39 is a control circuit schematic for a seed treater in accordance with an illustrative aspect of the present disclosure.

FIG. 40 is a flowchart illustrating a seed treatment method in accordance with an illustrative aspect of the present disclosure.

FIG. 41 is another flowchart illustrating a seed treatment method in accordance with an illustrative aspect of the present disclosure.

FIG. 42 is another flowchart illustrating a seed treatment method in accordance with an illustrative aspect of the present disclosure.

FIG. 43 is another flowchart illustrating a seed treatment method in accordance with an illustrative aspect of the present disclosure.

FIG. 44 is another flowchart illustrating a seed treatment method in accordance with an illustrative aspect of the present disclosure.

### DETAILED DESCRIPTION

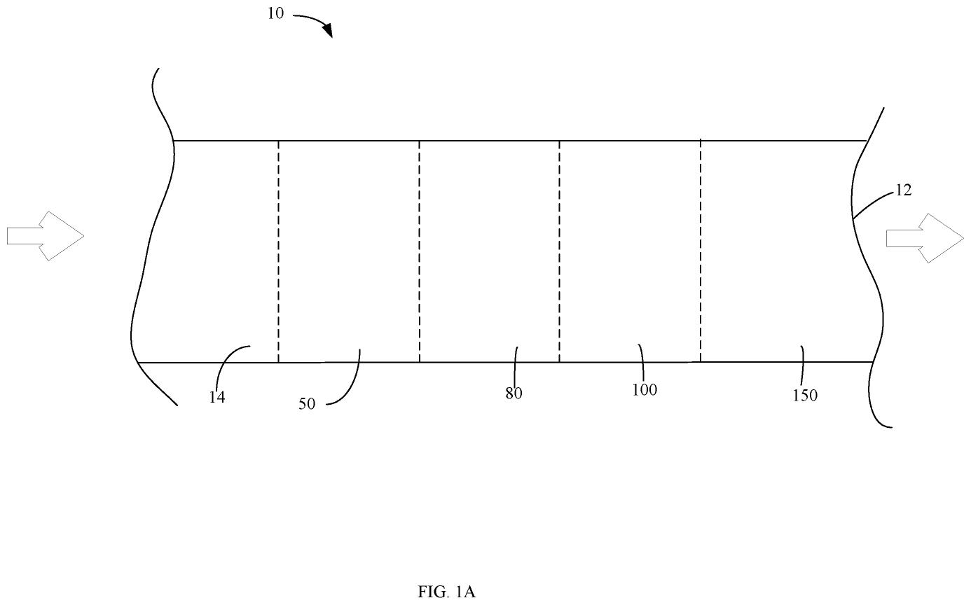

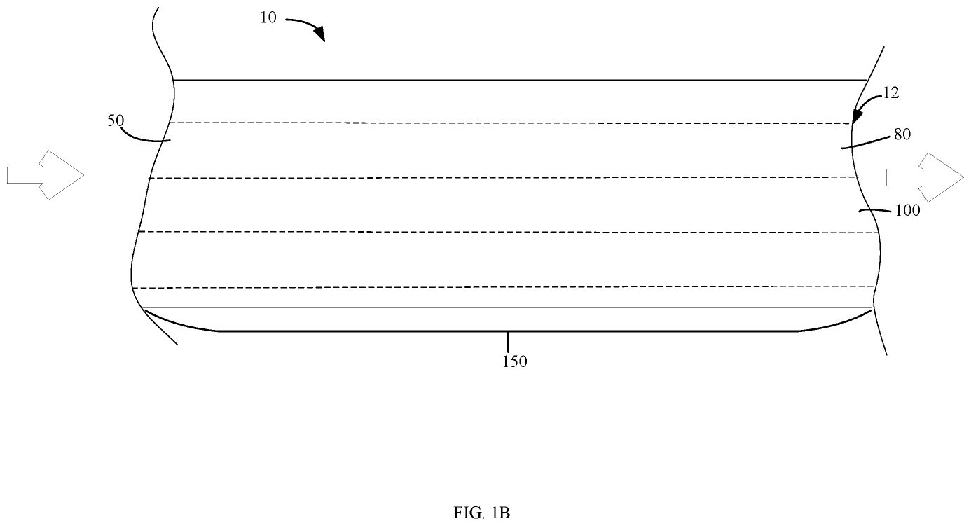

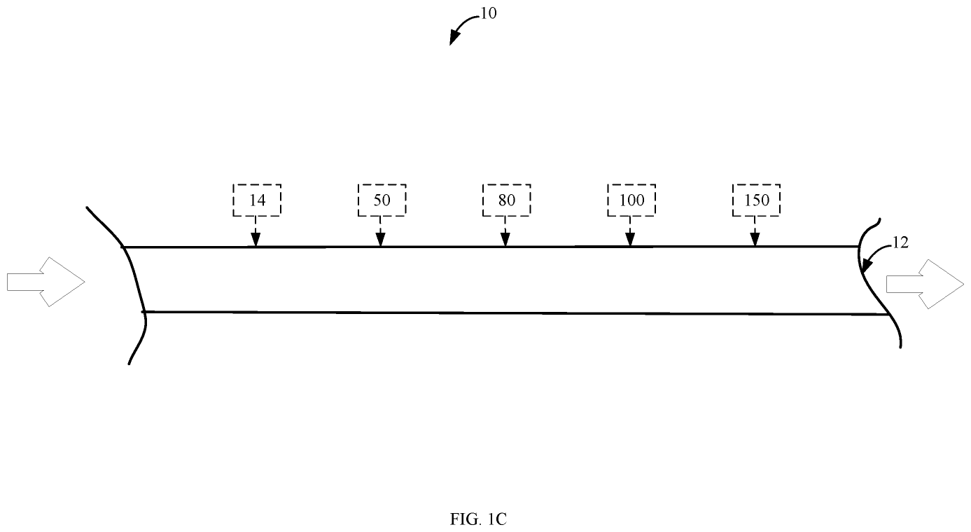

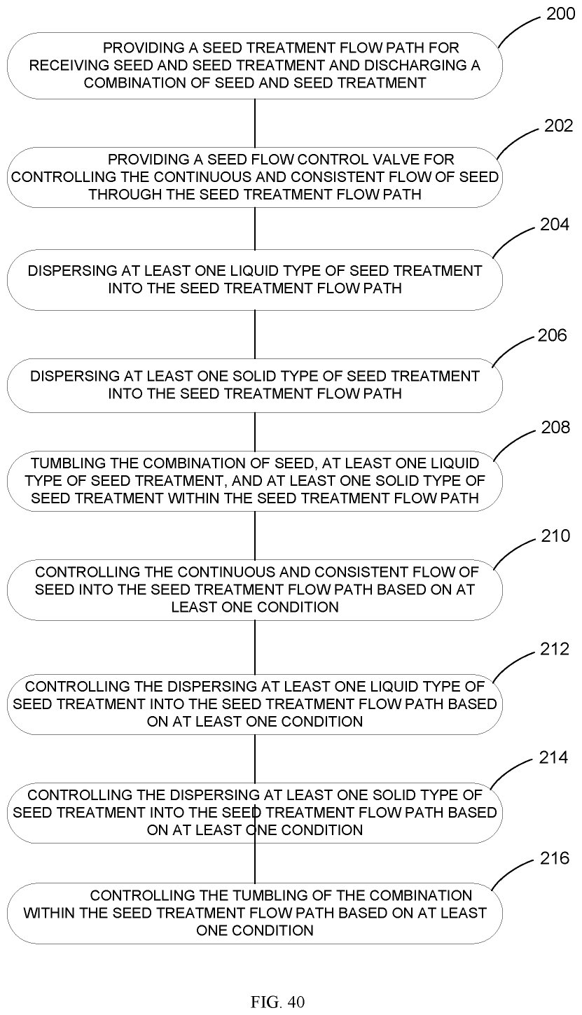

FIGS. 1A-39 provide various pictorial illustrations for exemplary aspects of a seed treater 10 in accordance with the objects, features, and advantages of the present disclosure. FIGS. 40-44 provide various pictorial illustrations for exemplary aspects of a seed treatment method in accordance with the objects, features, and advantages of the present disclosure.

The present disclosure contemplates many different apparatuses and varying arrangements, methods and systems for a continuous flow seed treater and seed treatment system as well as commercialization and use. Representative applications of methods and systems are described in this section as well as apparatus mechanisms and structures. These examples are provided solely to add context and aid in understanding of the described aspects of the disclosure. It will thus be apparent to one skilled in the art that the described aspects of the disclosure may be practiced without some and/or all of these specific details. In other instances, well known process steps have not been described in detail in order to avoid unnecessarily obscuring the described aspects. Other applications are possible, such that the following examples should not be taken as limiting.

In the following detailed description, references are made to the accompanying drawings, which form a part of the description and show, by way of illustration, specific aspects in accordance with the methods and systems of the present disclosure. Although aspects of the disclosure are described in sufficient detail to enable one skilled in the art to practice the described aspects, it is understood that these examples are not limiting; other aspects may be used, and changes may be made without departing from the spirit and scope of the described aspects of the disclosure.

It will also be understood that, although the terms first, second, next, lastly, etc. may be used herein to describe various elements, these elements should not be limited by such terms. These terms are only used to distinguish one element from another. For example, a first step could be termed a second step, and, similarly, a second step could be termed a first step, without departing from the spirit and scope of the present disclosure.

The terminology used herein is for the purpose of describing particular aspects of the disclosure only and is not intended to be limiting of the present disclosure. As used in the description of the invention and the appended claims, the singular forms “a”, “an” and “the” are intended to include the plural forms as well, unless the context clearly indicates otherwise. By way of example only, while the singular form of numerous components and steps are described in various aspects of the disclosure herein, it will be apparent that more than one of such components and/or steps can be used to accomplish the same. It will also be understood that the term “and/or” as used herein refers to and encompasses any and all possible combinations of one or more of the associated listed items. It will be further understood that the terms “comprises” and/or “comprising,” when used in this specification, specify the presence of stated features, functions, integers, steps, operations, elements, and/or components, but do not preclude the presence and/or addition of one or more other features, integers, steps, operations, elements, components, and/or groups thereof. It will be similarly understood that the terms “including,” “include,” “includes”, “such as” and the like, when used in this specification, are intended to be exemplary and should be construed as including, but not be limited to, all items recited thereafter. As used herein, the term “if” may be construed to mean “when” or “upon” or “in response to determining” or “in response to detecting,” depending on the context.

As used herein, the term “seed” includes seeds of any type of plants, including, but not be limited to, row crops, cereals, grains, oilseeds, fruits, vegetables, turf, forage, ornamental, nuts, tobacco, plantation crops and the like (including, without limitation, cotton and other fiber and hemp and related seeds).

As used herein, the terms “substance” and/or “seed-applied substance” and/or “seed treatment” may include any composition applied to seeds prior to the seeds being planted (e.g., when the seed comes in contact with the soil in a field). The seed-applied substance(s) can include active ingredients, other substances, combinations of more than one active ingredient and/or other substances, and/or mixtures having one or more active ingredients and/or one or more other substances. The active ingredients can include any type of substance that causes something to occur (for example, the ingredient(s) in a pesticide that impact the pest, the ingredients in a fungicide that impact the disease and/or plant growth, health and/or vigor, the ingredients in a nematicide that impact the nematode, the ingredients in an inoculant and/or other plant growth and/or health substance that cause the plant to improve its growth, health and/or vigor). The active ingredients can include any past, present and/or future active ingredients and can be chemicals, biologicals (including, without limitation, fungal, bacterial, parasitic, insects and other living organisms), biostimulants, micronutrients, and/or other compositions. Examples of some current potential active ingredients include nitrogen, clothianidin, ipconazole, trifloxystrobin, imidacloprid, metalaxyl, pyraclostrobin, Bradyrhizobium, myclobutanil, thiamethoxam, abamectin, mefonoxam, fludioxonil, fipronil, azoxystrobin, cyantraniliprole, Rynaxypyr®, and the like. The other substances typically do not impact the target (for example pest, disease, nematode and/or plant growth, health and/or vigor), but can be helpful to include for a variety of reasons, including, but not be limited to, causing the active ingredients to be at the appropriate levels and/or concentrations to be efficacious but not harmful to the seed and/or plant, helping the active ingredient affix and/or stick to the seed, helping the treated seeds not stick to each other and/or other objects, improving the color of the treated seed (e.g., to indicate the seed is treated with a pesticide), increasing the number and/or amount of active ingredients a seed can absorb and/or otherwise carry and the like. Examples of some of these other substances include polymers, pigments, binders, surfactants, colorants, coatings, and other additives. The seed-applied substances can take any form, including, but not be limited to, wet and dry substances.

FIGS. 1A-1C show pictorial representations of various configurations a seed treatment flow path 12 in accordance with exemplary aspects of the present disclosure. Seed treatment may constitute any of a solid seed treatment, liquid seed treatment, or any other substance that may be applied to a seed along a seed treatment flow path 12 of a seed treater 10. As shown in FIG. 1A, a seed treater 10 may include a seed flow control system 14, a liquid seed treater system 50, a solid seed treater system 80, a tumbling system 100, and a control system 150 that may be incorporated on a seed treatment flow path 12. A seed treatment flow path 12 may be configured to receive seed and seed treatment and discharge a combination of seed and seed treatment. As shown in FIG. 1A, the seed flow control system 14 may allow seed to enter the seed treatment flow path 12. In one aspect, the seed flow control system 14 may include a valve 36 which may further include a non-planar gate 42 which could be configured to open and close an opening 46. Still shown in FIG. 1A, a liquid seed treater system 50 may then disperse at least one liquid seed treatment into the seed treatment flow path 12, and a solid seed treatment system 80 may then disperse at least one solid seed treatment into the seed treatment flow path 12. In one aspect, the liquid seed treater system 50 may be downstream of the seed flow control system 14, and the solid seed treatment system 80 may be downstream of the liquid seed treater system 50. A tumbling system 100 may be downstream of the seed flow control system 14, a liquid seed treater system 50, and a solid seed treater system 80. However, it is contemplated that various arrangements of the systems could be utilized. A control system 150 may be utilized to control the various systems and their respective components.

The combined seed, at least one liquid seed treatment, and at least one solid seed treatment created from the seed flow control system 14, the liquid seed treater system 50, and the solid seed treater system 80 may then be further mixed and/or combined in a tumbling system 100. The tumbling system 100 is contemplated to be any type of actuatable housing, and may include a variety of components including but not limited to baffles 104, ridges, heating/cooling elements, sensors, ventilators, discharges, gates, grates, textures or any other conceivable mechanism or design. It is also contemplated that the tumbling system 100 may be made of steel, aluminum, plastic, or any other type of material suitable for mixing materials. The tumbling system 100 may be downstream of the seed flow control system 14, liquid seed treater system 50, and solid seed treater system 80, but it is contemplated that the tumbling system may be arranged elsewhere.

A control system 150 may control the continuous and consistent flow of seed in the seed flow control system 14 into the seed treatment flow path 12. A control system 150 may further control the dispersing of the at least one liquid type of seed treatment from the liquid seed treater system 50 into the seed treatment flow path 12 based on at least one condition or operating parameter, and control system 150 may also control the dispersing of the at least one solid type of seed treatment from the solid seed treater system 80 into the seed treatment flow path 12 based on at least one condition or operating parameter. Further still, a control system 150 may control the tumbling of the tumbling system 100 containing the combined seed, liquid, and solid materials in the seed treatment flow path 12 based on at least one condition or operating parameter. The at least one condition or parameter may include any variety of factors stemming from environment, seed, or seed treatment. Environmental factors or conditions may include but are not limited to ambient or environmental temperature, humidity, barometric pressure, thermal barrier properties, or any other environment that may impact a seed or seed treatment on a seed flow path 12. Seed conditions or characteristics may include but are not limited to seed type, seed sweating, flowability, thermal properties, volume, mass, coat hardness, shape, texture, coat thickness, crude fat, soluble protein, sugar, gibberellins and abscisic acid, adhesiveness, or any other properties of a seed that may require adjustments to the seed flow path 12. Seed treatment factors may include but are not limited to the substances applied to the seed, such as solid or liquid substances, as well as the seed treatment process itself. Factors relating to substances applied to the seed may include but are not limited to ingredients, flowability, drying factors, temperature effects, viscosity, humidity effects, chemical interactions, wettability, or any other factors of relating to the substances that may be used in a seed treater 10 that may require adjustments to the seed flow path 12 or seed treater 10. Factors relating to the seed treatment process itself could be seed flow rate, liquid dispersion rate, solid dispersion rate, tumbling rate, tumbling angle, amount of time in tumbler, amount of residual left over on any components of seed treater 10, or any other factors in the seed treatment process that may require adjustments to the seed flow path 12 or seed treater 10.

As shown in FIG. 1B, a seed treatment flow path 12 of a seed treater 10 may include a seed flow control system 14, liquid seed treater system 50, solid seed treater system 80, a tumbling system 100, and a control system 150. The control system 150 may control the liquid seed treater system 50 to control the dispersion rate of at least one liquid type of seed treatment, and the control system 150 may also control the solid seed treater system 80 to control at least one solid type of seed treatment within the seed treatment flow path 12. The control system 150 may slow the travel of at least one liquid seed treatment from the liquid seed treater system 50 as well as slow the travel of at least one solid seed treatment from the solid seed treater system 80 through the seed treatment flow path 12. In other aspects, the control system 150 may speed up the travel of at least one liquid seed treatment from the liquid seed treater system 50 as well as speed up the travel of at least one solid seed treatment from the solid seed treater system 80 on the seed treatment flow path 12. The combined seed, liquid seed treatment, and solid seed treatment created from a liquid seed treater system 50 and a solid seed treater system 80 may be further mixed in a tumbling system 100 within the seed treatment flow path 12. The control system 150 may decrease and/or increase the rate of tumbling in the tumbling system 100 by decreasing and/or increasing the rotations per minute (RPM) of the rate of tumbling. The increase or decrease in the rate of tumbling may be based on at least one condition or operating parameter. Parameters may include but are not limited to environment, seed, and seed treatment. Additionally, the control system 150 may decrease and/or increase the rate of tumbling in the tumbling system 100 by decreasing and/or increasing the number of baffles 104. Further still, the control system 150 may change the throughput of the combination through the seed treatment flow path 12 by changing an attitude of the seed treatment flow path. Additionally, a control system 150 may detect residual from the combination in the seed treatment flow path by means of a sensor or other conceivable ways to detect residual.

The control system 150 may have a calibration node configured to compare the calculated remaining residue and the calculated treated seed parameters or the at least one condition with the as-treated seed and actual remaining residue and adjust different machine parameters of the seed treatment flow path 12. In another aspect, the calibration node compares the calculated seed disbursement with the actual seed disbursement. In still another aspect, the calibration node compares the calculated liquid material or seed treatment disbursement with the actual liquid material disbursement or seed treatment disbursement. In yet another aspect, the calibration node compares the calculated solid disbursement with the actual solid disbursement The calibration node can calibrate different machine parameters by making operational adjustments to minimize any differences between the calculated seed treatment data and the measured seed treatment data (i.e., data acquired from one or more operations of one or more nodes/modules for providing and from measuring an as-treated seed and the remaining residue).

The control system 150 may have a data tagging, logging, and storage node. The data tagging, logging and storage node communicates with different parts or aspects of the seed treatment flow path 12 or the seed treater 10 and may be housed in the controller 154. The data tagging, logging and storage node may receive data from different parts of the seed treatment flow path 12 and tag the data. The tagging allows for data to be easily organized and labeled. The tagging may consist of where the data was acquired, where the data was communicated through, where the data should be stored, or where the data should be communicated to. The data can be logged and stored in a database. Prior to reaching the data tagging, logging, and storage node, the data may be communicated to a machine learning and artificial intelligence node of the control system 150 and then the data may proceed to the data tagging, logging and storage node. The data tagging, logging, and storage node may contain one or more databases for storing data.

The present disclosure contemplates that many different types of machine learning and artificial intelligence may be employed by the machine learning and artificial intelligence node, and therefore, the one or more machine learning and artificial intelligence layers may include, but are not limited to, k-nearest neighbor (kNN), logistic regression, support vector machines or networks (SVM), linear regression, logistic regression, decision tree, naïve Bayes, K-Means, Random Forest, dimensionality reduction algorithms, gradient boosting algorithms (e.g., GBM, XGBoost, LightGBM, CatBoost), and/or more neural networks. Regardless, the use of machine learning and artificial intelligence in the framework and workflow of the present disclosure enhances the utility of analyzing known and/or collected data and its various components by automatically and heuristically constructing appropriate relationships, mathematical or otherwise, relative to the seed, seed treatment, and environment variables influencing follow-on outcomes such as continuously treating seed and adjustment of amounts and types of inputs into the seed treatment flow path 12, the seed treater 10, and processes. The machine learning and artificial intelligence node may be housed in the controller 154 and may be associated with one or more databases. For example, the machine learning and artificially intelligence node may analyze at least one of the one or more seed treatment inputs, the at least one of the one or more seed treater operations, the one or more environmental inputs for treating seed at the controlled rate and converge actual seed treatment results with programmed seed treatment parameters. Such analysis may be alone or performed in combination with one or more points of human inspection, such as by visual inspection and/or conducting one or more tests.

The machine learning and artificial intelligence node may be configured to apply one or more machine learning and artificial intelligence models to the data. For example, in at least one aspect, a machine learning and artificial intelligence node monitors data, such as machine operational data or parameters to, for example, monitor the health, operational accuracy, and to adjust, report problems, and fine tune operations. In one aspect, the machine learning and artificial intelligence node monitors operations of the seed treatment flow path 12 or the seed treater 10 and, using present, historical, and predictive data tagged, logged, and stored, monitors the health, operational accuracy, and adjusts operations, reports problems, and fine tunes batch processing and accuracy. Measurements taken for identifying, tagging, logging, and storing data based on operation of the seed treatment flow path 12 and modules can be, in at least one aspect, performed and provided, at least in part, by one or more parts or aspects of the seed treatment flow path 12. The machine learning and artificial intelligence node can calibrate operations of the nodes and/or modules using data from the nodes and modules by making, for example, operational adjustments to minimize any differences between the calculated seed treatment data and the measured seed treatment data (i.e., data acquired from one or more operations of one or more nodes/modules for providing and from measuring an as-treated seed).

As shown in FIG. 1C, a seed treatment flow path 12 of a seed treater 10 may include a seed flow control system 14, a liquid seed treater system 50, a solid seed treater system 80, a tumbling system 100, and a control system 150. As shown in FIG. 1C, the seed flow control system 14 may allow seed to enter the seed treatment flow control path 12. In one aspect, the seed flow control system 14 may include a valve 36 which may be operably configured to introduce a continuous flow of seed into the seed treatment flow path 12 at a seed flow rate. Still shown in FIG. 1C, a liquid seed treater system 50 may then disperse at least one liquid seed treatment into the seed treatment flow path 12 at a liquid dispersion rate, and a solid seed treater system 80 may then disperse at least one solid seed treatment into the seed treatment flow path 12 at a solid dispersion rate. In one aspect, the liquid seed treater system 50 may include a liquid disperser which may be downstream of the seed flow control system 14 which may include a valve 36, and the solid seed treater system 80 may be downstream of the liquid seed treater system 50. However, it is contemplated that various arrangements of the systems could be utilized.

The combined seed, at least one liquid seed treatment, and at least one solid seed treatment created from the seed flow control system 14, the liquid seed treater system 50, and the solid seed treater system 80 may then be further mixed and/or combined in a tumbling system 100 at a tumbling or mixing rate. The tumbling system 100 is contemplated to be any type of actuatable housing, and may include a variety of components including but not limited to baffles 104, ridges, heating/cooling elements, sensors, ventilators, discharges, gates, grates, textures or any other conceivable mechanism or design. It is also contemplated that the tumbling system be made of steel, aluminum, plastic, or any other type of material suitable for mixing materials. The tumbling system 100 may be downstream of the seed flow control system 14, the liquid seed treater system 50, and the solid seed treater system 80, but it is contemplated that the tumbling system 100 may be arranged elsewhere.

A control system 150 may control the continuous and consistent flow of seed in the seed flow control system 14 into the seed treatment flow path 12. A control system 150 may further control the dispersing of the at least one liquid type of seed treatment from the liquid seed treater system 50 into the seed treatment flow path 12 based on one or more conditions, and control system 150 may also control the dispersing of the at least one solid type of seed treatment from the solid seed treater system 80 into the seed treatment flow path 12 based on one or more conditions. Further still, a control system 150 may control the tumbling of the tumbling system 100 containing the combined seed, liquid, and solid materials in the seed treatment flow path 12 based on one or more conditions. It is further contemplated that control system 150 may be configured to control the seed flow control system 14, liquid seed treater system 50, and solid seed treater system 80 at a set rate based on one or more conditions. In other aspects, it is contemplated that a control system 150 may automatically adjust the dispersion rates of the systems individually or in unison based on one or more conditions. In alternative aspects of the present disclosure, the dispersion rates of the systems may be manually adjusted using the control system 150 or rates selected by the control system 150. The one or more conditions may include a variety of factors stemming from environment, machine operating parameters, seed, liquid materials, solid materials, and seed treatment. The at least one condition or parameter may include any variety of factors stemming from environment, seed, or seed treatment. Environmental factors or conditions may include but are not limited to ambient or environmental temperature, humidity, barometric pressure, thermal barrier properties, or any other environment that may impact a seed or seed treatment on a seed flow path 12. Seed conditions or characteristics may include but are not limited to seed type, seed sweating, flowability, thermal properties, volume, mass, coat hardness, shape, texture, coat thickness, crude fat, soluble protein, sugar, gibberellins and abscisic acid, adhesiveness, or any other properties of a seed that may require adjustments to the seed flow path 12. Seed treatment factors may include but are not limited to the substances applied to the seed, such as solid or liquid substances, as well as the seed treatment process itself. Factors relating to substances applied to the seed may include but are not limited to ingredients, flowability, drying factors, temperature effects, viscosity, humidity effects, chemical interactions, wettability, or any other factors of relating to the substances that may be used in a seed treater 10 that may require adjustments to the seed flow path 12 or seed treater 10. Factors relating to the seed treatment process itself could be seed flow rate, liquid dispersion rate, solid dispersion rate, tumbling rate, tumbling angle, amount of time in tumbler, amount of residual left over on any components of seed treater 10, or any other factors in the seed treatment process that may require adjustments to the seed flow path 12 or seed treater 10.

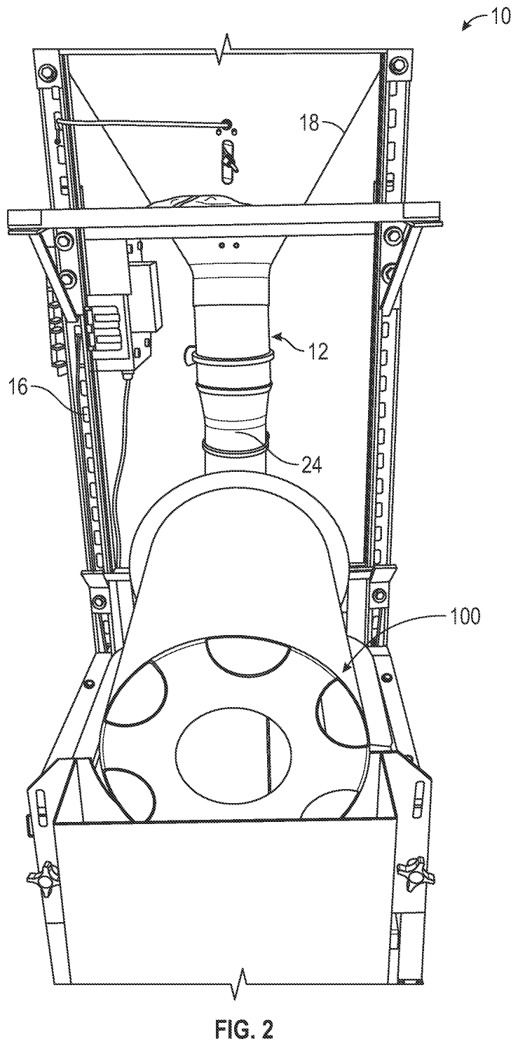

FIG. 2 shows a perspective view of a seed treater 10 in accordance with an illustrative aspect of the present disclosure. The seed treater 10 may include treater framework 16 for the seed treater 10. As shown, a seed hopper 18 may be supported by the treater framework 16, which may be positioned to support a seed treater 10 vertically, but it is contemplated a treater framework may be arranged diagonally, horizontally, or in any other conceivable arrangement to help direct seed flow on a seed treatment flow path 12. A seed hopper 18 may be positioned to convey seed onto a seed treatment flow path 12. A conduit 24 may be included in the seed treater 10 to direct seed and seed treatment flow from the seed hopper 18. A seed treater 10 may also include a tumbling system 100, which may be located downstream of the seed hopper 18 and connected to conduit 24 of the seed treater 10.

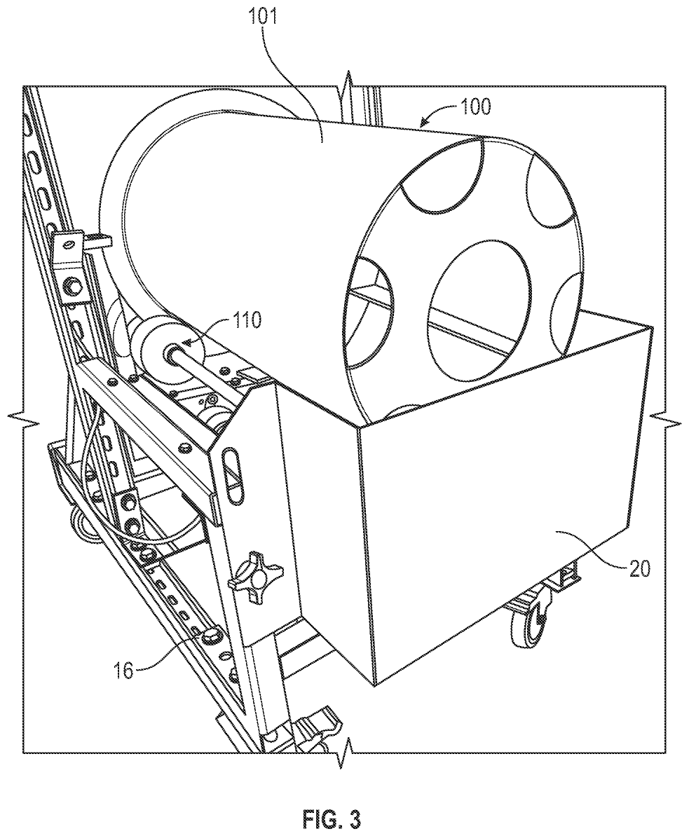

FIG. 3 shows an end perspective view of a seed treater 10 in accordance with an illustrative aspect of the present disclosure. A seed treater 10 may include a tumbling system 100. A tumbling system 100 may include a tumbler or drum 101, and the tumbling system 100 may be supported by the treater framework 16 of the seed treater 10. The drum 101 may be supported and arranged on a cradle and drive system 110. The cradle and drive system 110 may also be supported or incorporated onto the treater framework 16 of the seed treater system 10. As further shown in FIG. 3, a seed treater system 10 may include a cover 20 for collecting discharged materials or otherwise providing protection to the drum 101.

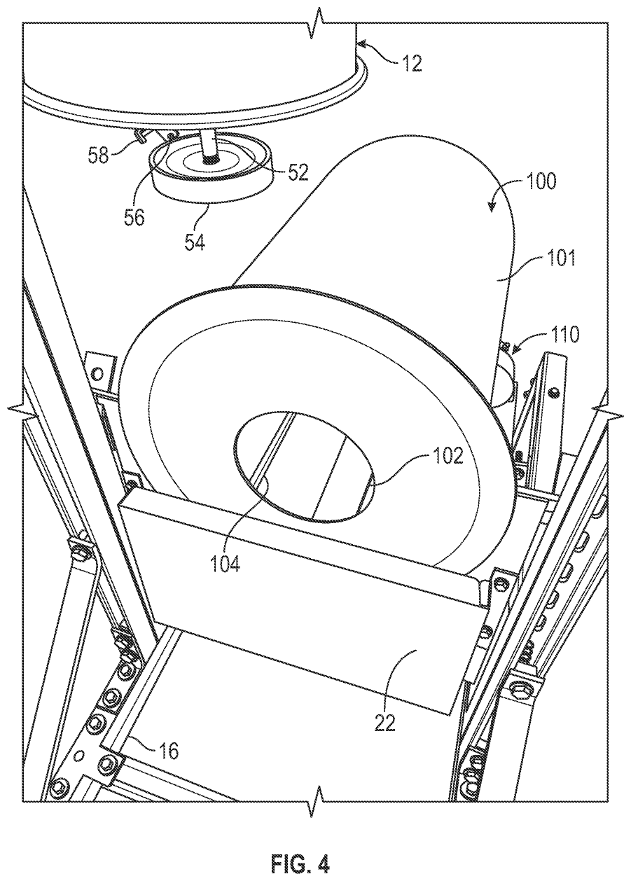

FIG. 4 shows another end perspective view of a seed treater 10 in accordance with an illustrative aspect of the present disclosure. A seed treater 10 may include a seed flow path 12 that travels through a liquid seed treater system 50. The liquid seed treater system 50 or the seed flow path 12 may include a shaft 52, an atomizing wheel 54, liquid plumbing 56, and a discharge 58. An atomizing wheel 54 may be connected to a shaft 52 which may allow the atomizer to rotate at a rate which may be controlled by a controller 154. Liquid plumbing 56 may transport and deliver a liquid, such as a liquid type of seed treatment to the atomizer wheel 54 at a discharge 58 to be atomized. An atomizing wheel 54 may be a rotary atomizer and may have a variety of different surfaces for atomizing, such as flat, a vaned disc, cup, slotted wheel, or any other conceivable surface that may be utilized in atomizing a liquid. The atomizer may also be a rotary, pressure swirl, twin fluid atomizer or any other conceivable atomizer or similar mechanism. The atomizing system may be operably configured to receive at least one liquid type of seed treatment from a liquid disperser 58 for atomizing at least one type of liquid type of seed treatment at an atomizing rate. Further, the atomizing rate may be under the operation of a controller 154. A liquid seed treater system 50 may be operably configured to introduce at least one liquid type of seed treatment in a seed treatment flow path 12 at a liquid dispersion rate, which may be controlled by a controller 154 and/or control system 150.

The seed treater 10 may be supported by a treater framework 16 and include a tumbling system 100 also supported by a treater framework 16. As shown in FIG. 4, a tumbling system 100 may include a tumbler or mixing drum 101, and the drum 101 may be supported and/or arranged on a cradle and drive system 110, which may also be supported by or attached to a treater framework 16. The drum 101 of the tumbling system 100 may include an opening 102. The tumbler opening 102 may be circular in shape as depicted in FIG. 4, but it is contemplated that other shapes may be utilized for the intake of materials. The opening 102 may be an infeed for receiving seed and seed treatment such as the liquid material and/or solid material. The drum 101 may also include one or more baffles 104 which may be utilized to control the mixing of the combined seed and seed treatment. The seed treater system 10 may also include a panel 22 adjacent the opening 102 of the tumbler 101. A panel 22 may be a removable panel and may provide protection to the drum 101 or prevent undesired movement of the drum 101. Panel 22 may further be utilized to protect components and mechanisms positioned beneath a drum 101 or prevent injuries for a user of the seed treater 10.

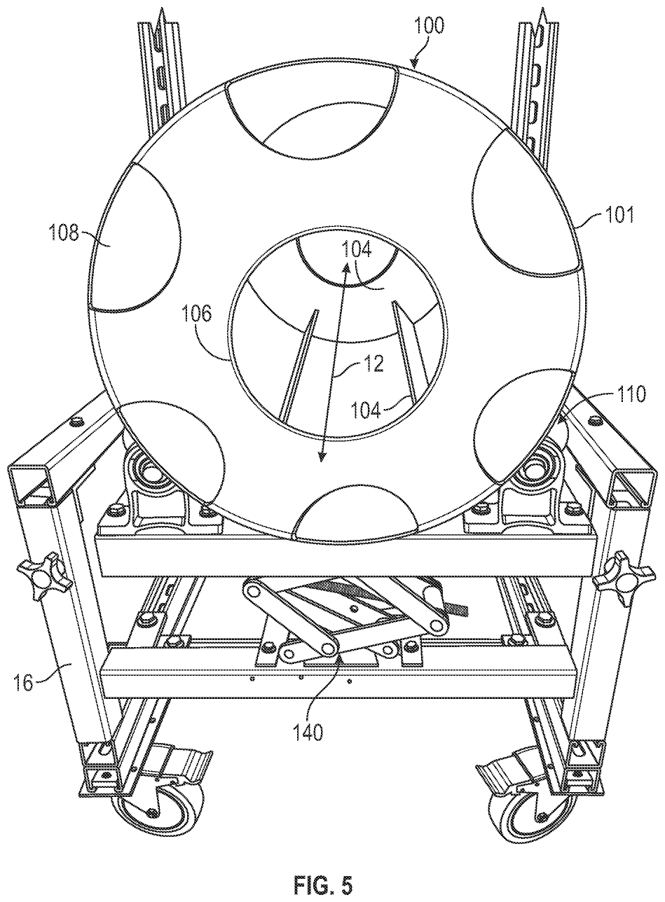

FIG. 5 shows an elevation view of an end of a seed treater 10 in accordance with an illustrative aspect of the present disclosure. A seed treater 10 may include a seed flow path 12 and a frame 16 to support the seed treater 10 and components of the seed treater 10. As shown in FIG. 5, a seed treater 10 may include a tumbling system 100. A tumbling system 100 may be used for tumbling a combination of seed, at least one liquid type of seed treatment, and at least one solid type of seed treatment within a seed treatment flow path 12. The tumbling system 100 may include a drum 101 which may include one or more baffles 104 located inside the drum 101 for directing or obstructing the flow of materials in a seed flow path 12. The drum 101 as shown in FIG. 5 is cylindrical in shape, however, it is contemplated that a drum 101 may be any type of actuatable housing and may be a variety of shapes including but not limited to a sphere, torus, ellipsoid, cone, or any other shape that may allow for different movement or positioning. While baffles 104 may be included on a drum 101 as shown, a drum 101 may be contemplated to utilize ridges, heating/cooling elements, sensors, ventilators, discharges, gates, grates, textures or any other conceivable mechanism or design that can be utilized in conjunction with a drum 101 for a variety of purposes. It may be further contemplated that the drum 101 be made of steel, aluminum, plastic, or any other type of material suitable for mixing materials. Further still, as show in FIG. 5, a drum 101 may include an opening 106 which may be used as an outlet or discharge end for discharging materials from the tumbling system 100 and seed treatment flow path 12. The opening 106 may be circular in shape as depicted in FIG. 5, but it is contemplated that other shapes may be utilized for discharging materials. As still shown in FIG. 5, additional openings 108 may be included on the drum 101 for discharging materials or ventilation within the drum 101. The drum 101 may be operably configured to assist in combining a seed and seed treatment within a seed flow path at a tumbling rate. Furthermore, as shown in FIG. 5, a seed treatment flow path 12 travels primarily through the center of a drum 101, but it is contemplated that different seed treatment flow paths may be utilized in a seed treater 10.

The drum 101 may be supported and/or arranged on a cradle and drive system 110, which may also be supported by or attached to frame 16. The cradle and drive system 110 may include a tilt control system 140 which may be operably configured to control the attitude of the seed treatment flow path 12. A drum 101 may be operably configured to assist in combining seed and seed treatment within the seed treatment flow path 12 at a tumbling rate, which may be controlled by a controller 154 and/or control system 150.

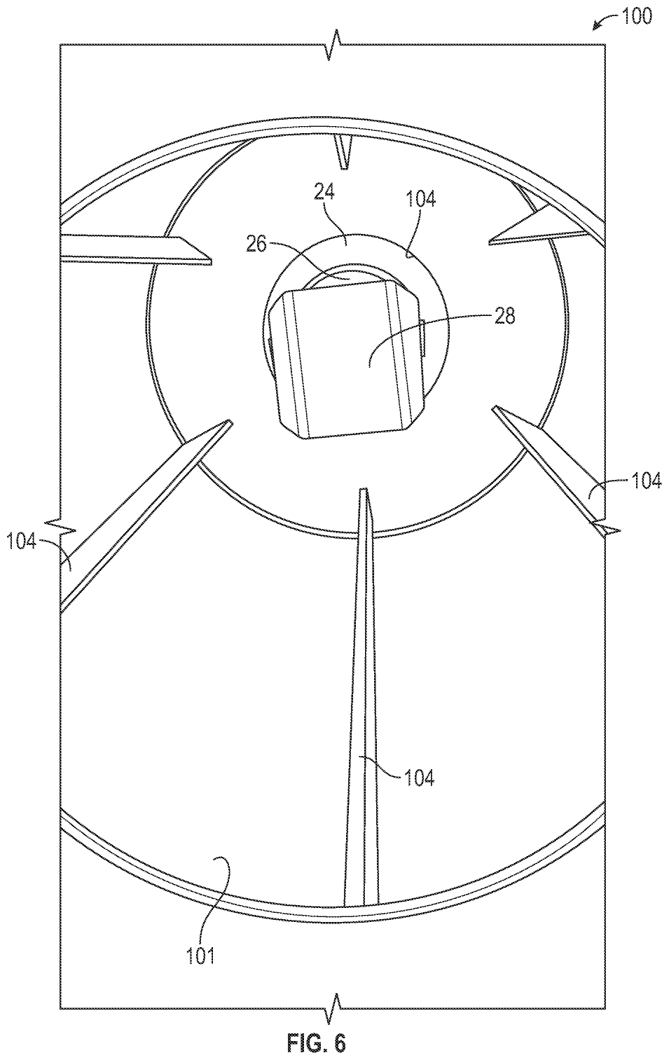

FIG. 6 shows an end elevation view of a baffle 104 of the seed treatment flow path 12 in accordance with an illustrative aspect of the present disclosure. As shown in FIG. 6, one or more baffles 104 may be included on a drum 101 of the tumbling system 100. The baffles 104 may be used to direct and/or obstruct the mixing of the seed and seed treatment within the drum 101. A conduit 24 may be utilized to connect the drum 101 of the tumbling system 100 to other components of the seed treater 10 to provide watertight flow of seed and seed treatment in the seed flow control system 12. An opening 26 between the inner drum 101 and conduit 24 may introduce seed and seed treatment to drum 101. A drum 101 may also include a damper 28.

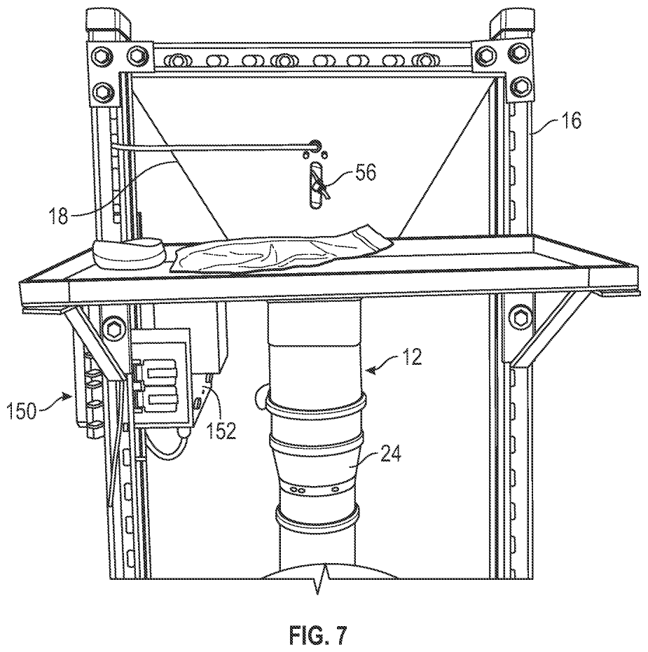

FIG. 7 shows an elevation view of a seed hopper 18, seed flow control system 14, and seed treatment flow path 12 in accordance with an illustrative aspect of the present disclosure. The seed hopper 18 may be supported by a treater framework 16 and arranged vertically to be the most upstream in the seed treatment flow path 12 of the seed flow control system 14. As shown in FIG. 7, the treater framework 16 may be configured to include a shelf for holding materials such as pumps, mixing equipment, or any other equipment deemed necessary for use in a seed flow path 12 of a seed treater 10. A conduit 24 may be positioned downstream of the seed hopper 18 to assist with and contain the flow of seed and seed treatment in the seed flow path 12. Liquid plumbing 56 may be included on the seed hopper 18 and may be arranged downstream from top opening of the seed hopper 18.

A control system 150 may also be included in the seed flow control system 14 and may be contained in a controller housing 152 that may be attached or mounted to a treater framework 16 for ease of access. The control system 150 may include controller 154, which may be configured for electromechanically controlling a rate for seed and seed treatment operations within a seed flow path 12. The control system 150 may communicate with one or more remote devices while controlling the rate for seed and seed treatment operations.

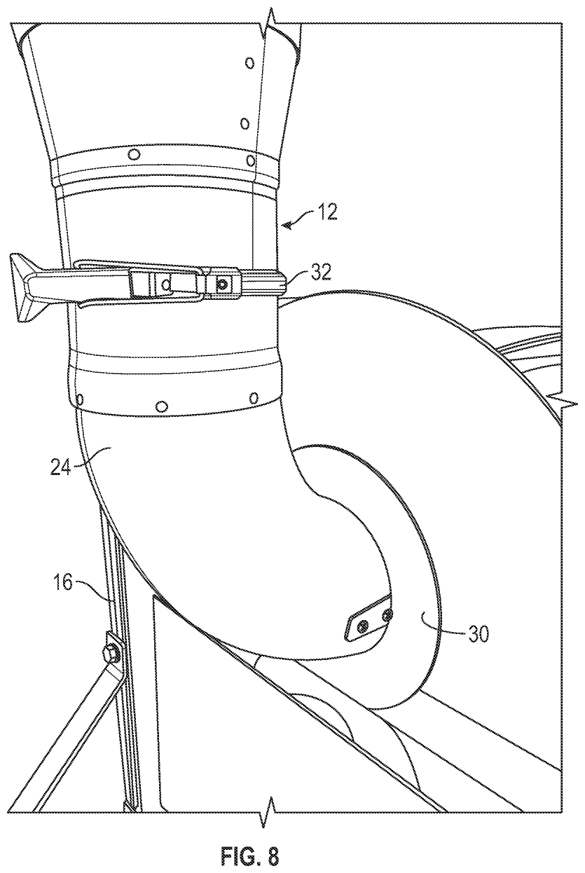

FIG. 8 shows a perspective view of a seed flow control system 14 and seed treatment flow path 12 in accordance with an illustrative aspect of the present disclosure. The seed flow control system 14 may be supported by a treater framework 16. A conduit 24 may be used to assist with the flow of seed and seed treatment in the seed treatment flow path 12 of the seed flow control system 14. A conduit 24 may be made of aluminum, plastic, concrete, steel, or any other material suitable for assisting with the flow of seed and seed treatment, and a conduit 24 may also be various shapes and sizes such as conical, cylindrical, curved, or any other shape or size conceivable for guiding the direction of seed and seed treatment in a seed treatment flow path 12.

To prevent leakage of seed or seed treatment in a seed treatment flow path 12, watertight seals may be used in conjunction with a conduit 24. As further shown in FIG. 8, a coupler 32 may be used to connect components of seed treater 10 and ensure gaskets are in place when clamping to create watertight seals between a conduit 24 and other components of a seed treater 10. Additionally, a flange 30 may be utilized to connect a conduit 24 and the opening 102 of the drum 101 of the tumbler system 100. The flange 30 may be utilized to create a watertight seal between the conduit 24 and the drum 101 to prevent leakage of seed or seed treatment in the seed flow path 12 of the seed treater system 14.

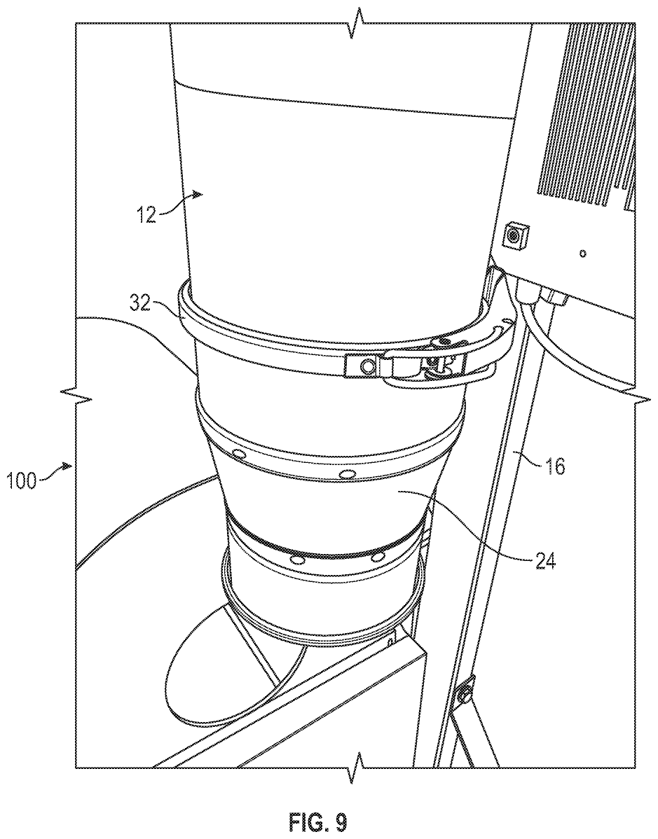

FIG. 9 illustrates a perspective view of a seed flow control system 14, tumbling system 100, and seed treatment flow path 12 in accordance with an illustrative aspect of the present disclosure. The seed flow control system 14 and the tumbling system 100 may be affixed to and/or supported by a treater framework 16. As shown, the seed flow control system 14 may include a conduit 24 for connecting components of the seed flow control system 14 and to direct the flow of seed and seed treatment within a seed treatment flow path 12. A coupler 32 may be used to connect components of the seed flow control system 14 and ensure gaskets are in place when clamping to create watertight seals. As shown in FIG. 9, a tumbling system 100 may be positioned downstream of a seed flow control system 14.

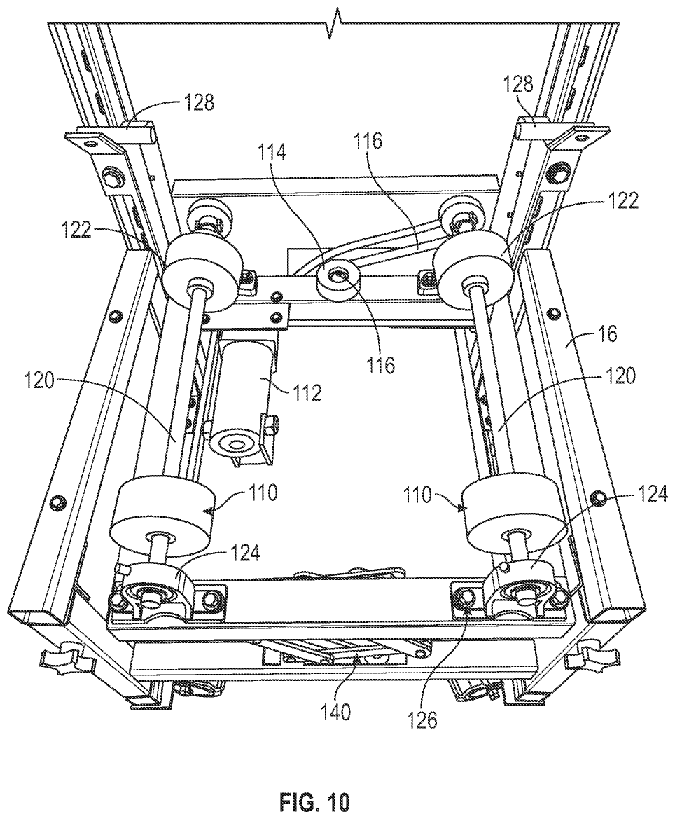

FIG. 10 shows a top perspective view of a cradle and drive system 110 of the tumbling system 100 in accordance with an illustrative aspect of the present disclosure. A tumbler 100 may be operably configured to assist in combining seed and seed treatment within the seed treatment flow path 12 at a tumbling rate, and a controller 154 of a control system 150 may be operably configured to control the tumbling rate of the drum 101. The cradle and drive system 110 may be affixed to or supported by a cradle frame 126 that may further hold bearings 124, shafts 120, and rollers 122. The cradle and drive support frame 126 may be affixed to or further supported by the main treater framework 16. The shafts 120 may be inserted through the bearings 124 and may be further inserted through the rollers 122. As shown in FIG. 10, there four rollers 122 may be positioned on the shaft 124, however it is contemplated that more rollers 122 or less rollers 122 may be utilized. It is also contemplated that the rollers 122 may be any size or shape that allows for rotation, and rollers 122 may be configured in any combination of differing shapes and sizes e.g. two small rollers used with two large rollers and so forth. FIG. 10 shows the rollers 122 may be positioned to adjacent and parallel to each other, however, in other aspects the rollers may be positioned in a variety of ways, such as in a circular formation, stair step formation, differing elevations, differing attitudes, or any other arrangement. The cradle and drive system 110 may further include a motor 112. A motor 112 may be operably connected to a cog 116 which may be connected to a drive member 114 to allow a shaft 120 to rotate. The rollers 122 may be inserted onto the shaft 120 to cause the drum 101 of the tumbling system 100 to rotate or actuate. The drum 101 may be positioned onto the rollers 122 of the cradle and drive system 110 with adjusters 128. Adjusters 128 may be positioned in a variety of ways to allow for various positions and placements of a drum 101 on the cradle and drive system 110.

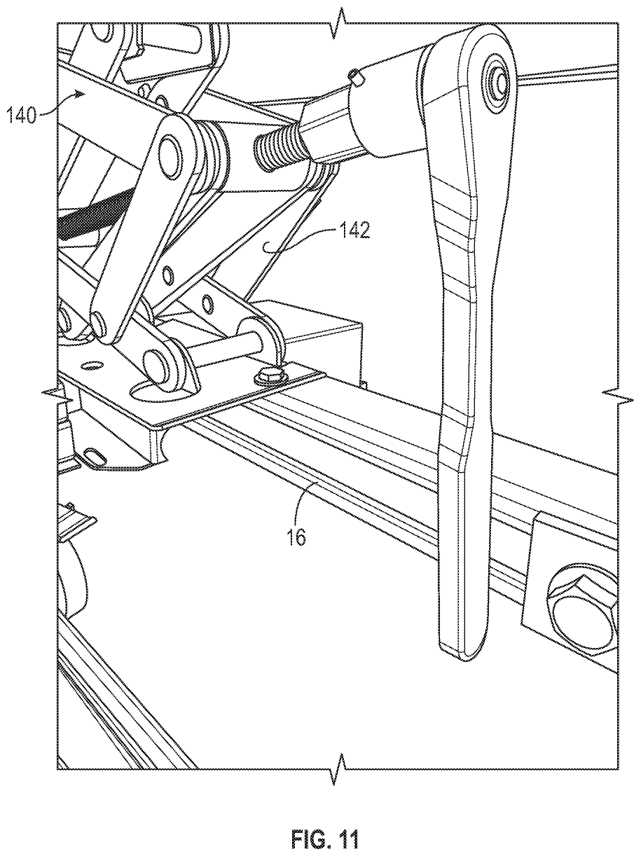

FIG. 11 depicts an elevation view of a tilt control system 140 of the tumbling system 100 in accordance with an illustrative aspect of the present disclosure. A tilt control system 140 may be operably configured to control the attitude of the seed treatment flow path 12 of seed treater 10. The tilt control system 140 may be removably attached to a treater framework 16. An actuator 142 may be used in the tilt control system 140 to adjust the tilt and/or attitude of the seed treatment flow path 12. The control system 150 may adjust to the tilt or attitude. As shown in FIG. 11, an actuator 142 may be a scissor jack and may be adjusted using a ratchet, but it is contemplated that other types of jacks, lifts, or mechanisms could be used to adjust and control tilt and attitude.

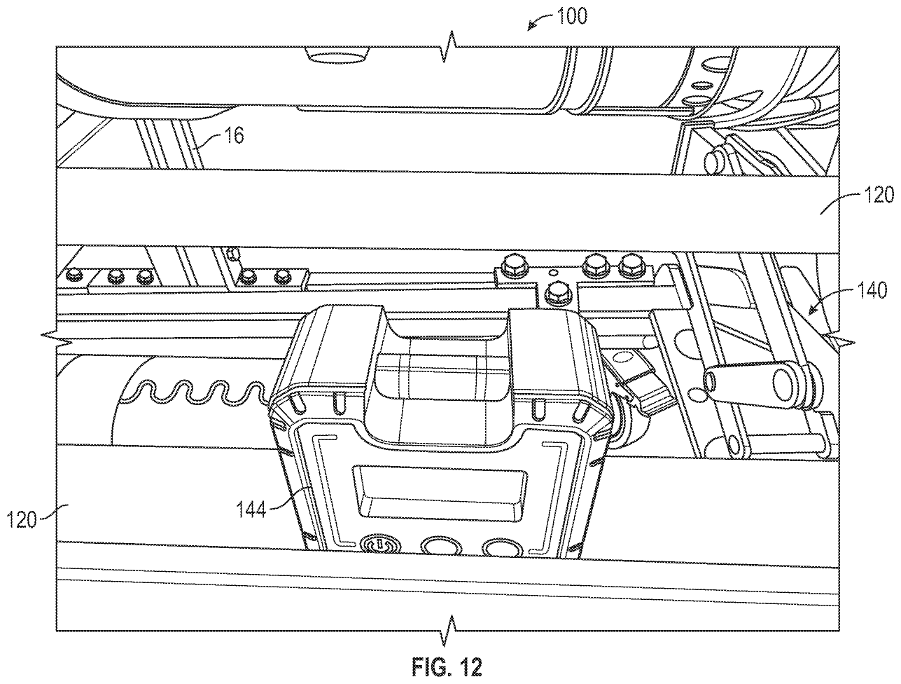

FIG. 12 shows a perspective view of a tilt control system 140 of the tumbling system 100 in accordance with an illustrative aspect of the present disclosure. A tilt control system 140 may be operably configured to control the attitude of the seed treatment flow path 12, and a tumbling system 101 of the tumbling system 100 may be the tilt-controlled vessel. A tilt control system 140 may include a sensor 144 for detecting and monitoring the tilt of the tumbler 101 of the tumbling system 100. The sensor 144 may be a digital angle gauge or a level gauge, and may be affixed to a cradle frame 126 of the cradle and drive system 110. The tumbling system 100, the cradle and drive system 110, and cradle frame 126 may be supported by or incorporated onto the main treater framework 16. The sensor 144 may be operatively connected to the control system 150 and may provide data to a control system or be operated by a control system.

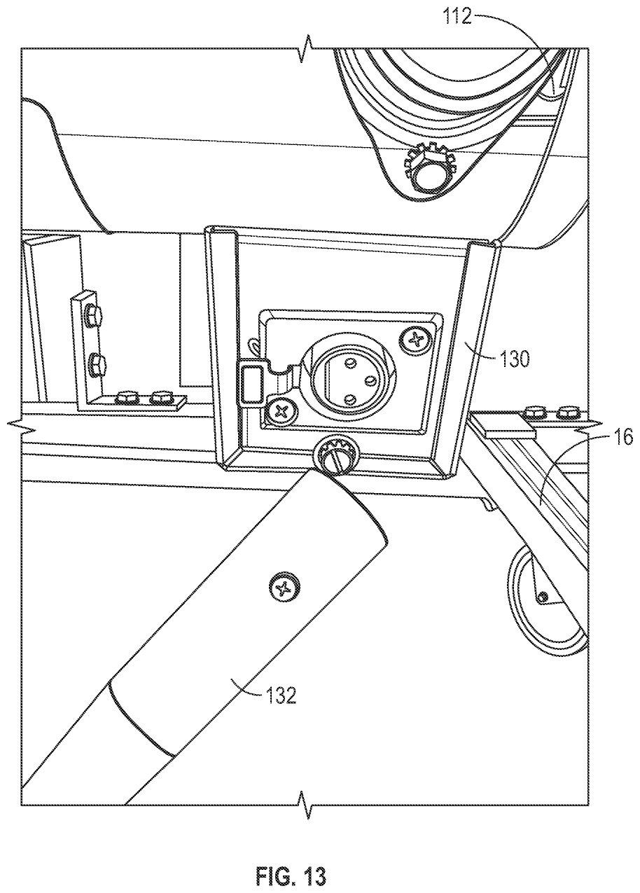

FIG. 13 illustrates a perspective view of a control component of the control system 150 for the cradle and drive system 110 in accordance with an illustrative aspect of the present disclosure. A control component may include a control cable 132, a connector 130, and a motor 112. A control cable 132 may be inserted into a connector 130 of the drum motor 112 to provide power to the motor 112 which may further enable operation of components of the cradle and drive system 110. The motor 112, connector 130, and control cable 132 may be operably connected to a controller 154 of a control system 150, and may be affixed to a cradle frame 126 of a cradle and drive system 110 which may be affixed to or supported by a treater framework 16. In other aspects, a motor 112, connector 130, and control cable 132 may be positioned in various locations.

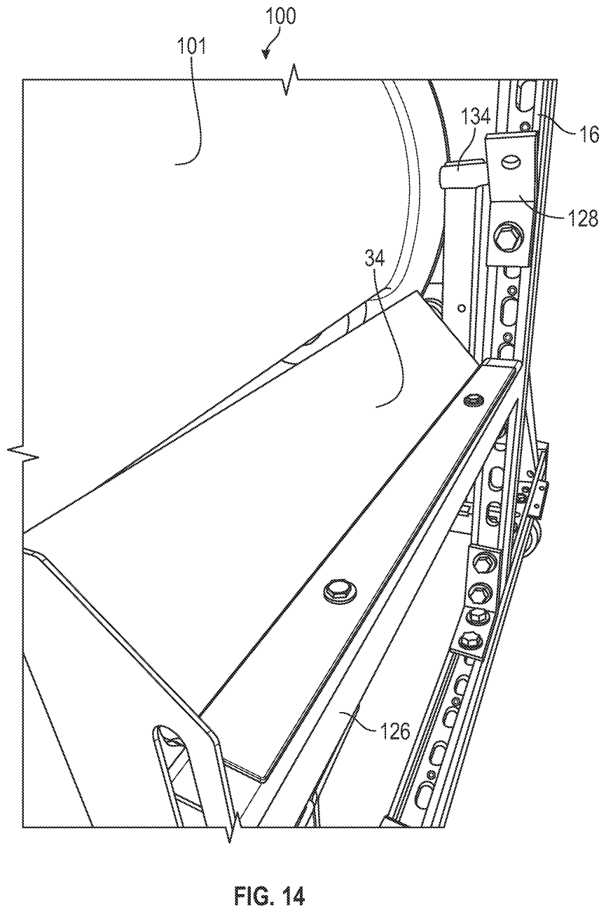

FIG. 14 shows a side perspective view of a tumbling system 100 and a treater framework 16 in accordance with an illustrative aspect of the present disclosure. A tumbling system 100 may be used in tumbling a combination of seed, at least one liquid type of seed treatment, and at least one solid type of seed treatment within a seed treatment flow path 12. A drum 101 may be included in a tumbling system 100. A drum 101 may include a mounting arm or drum pivot 134 for positioning a drum onto a cradle and drive system 110. The drum 101 and mounting arms 134 may be supported by adjusters 128 which may be removably attached to a treater framework 16, and may allow for adjusting the position of the drum 101. In one aspect, this configuration will allow a tumbler to rest freely upon the cradle and drive system 110 to best allow the tumbler 101 to rotate and/or actuate in a desirable manner. Additionally, a panel 34 may be removably attached to the cradle frame 126 of the cradle and drive system 110 to prevent the tumbler from becoming removed from the treater framework 16, to contain any materials or debris within the cradle and drive system 110 and tumbling system 100, to prevent damage to any part of the cradle and drive system 110 or the tumbling system 100, and as a safety precaution for system operators and injury prevention.

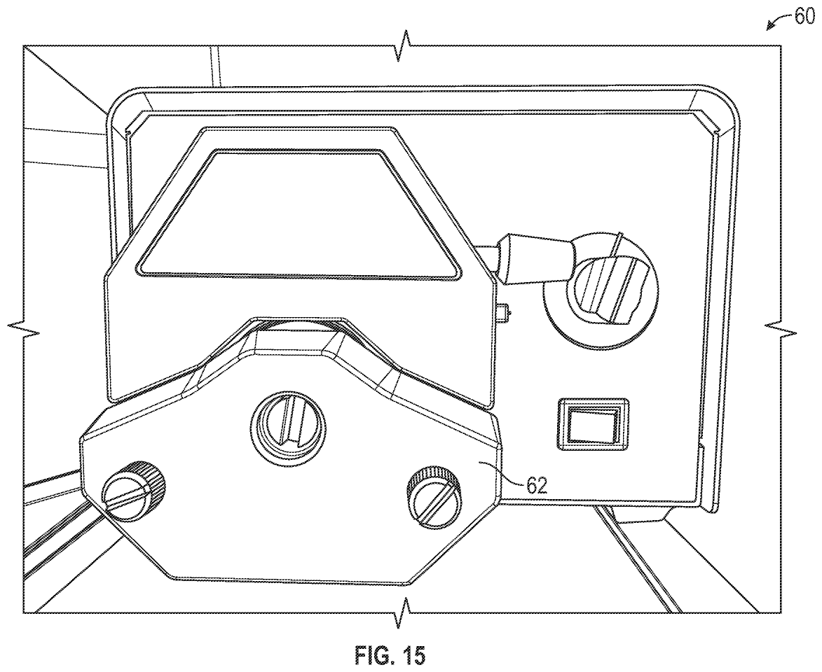

FIG. 15 depicts an elevation view of a pumping system 60 of the liquid seed treater system 50 in accordance with an illustrative aspect of the present disclosure. A pumping system 60 may consist of a liquid pump 60 operably configured to pump at least one liquid type of seed treatment to a liquid discharge or disperser 58, and a pump 60 may be a peristaltic pump. As shown in FIG. 15, a Masterflex Pump and Easy-Load pump head may be used as a pump 60 and pump housing 62, respectively, but it is contemplated that other pumps and pump housings may be utilized. Further still, a pumping system 60 may include a power switch for powering on the system, and may further include controls, such as a knob, to control the pumping.

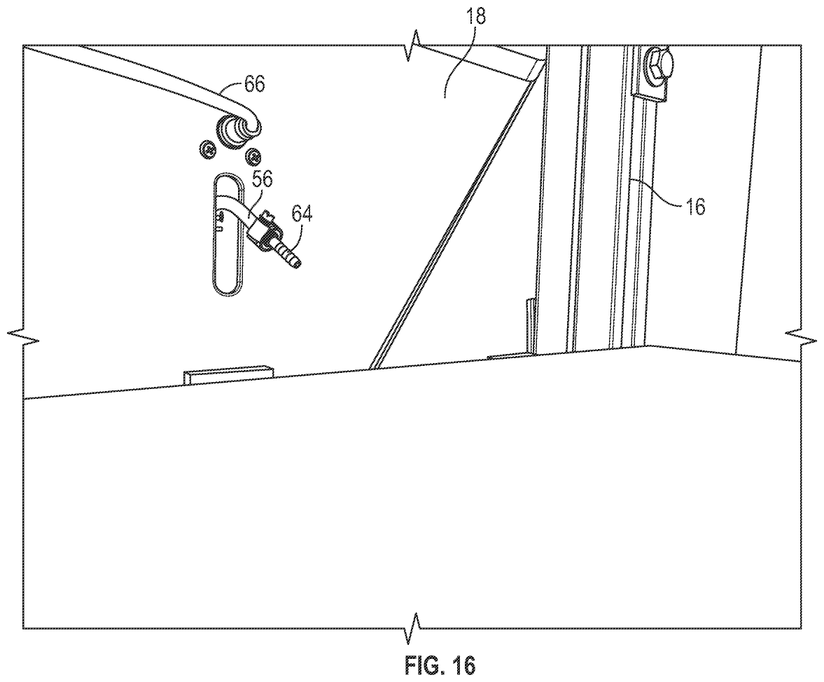

FIG. 16 is a perspective view of a plumbing configuration of the liquid seed treater system 50 in accordance with an illustrative aspect of the present disclosure. A liquid seed treater system 50 may include a discharge 58 in a seed treatment flow path 12 for dispersing at least one liquid type of seed treatment, where the discharge 58 may be located downstream of a valve. A plumbing configuration may include liquid plumbing 56 for transmitting a liquid into a seed treatment flow path 12. Connected to the liquid plumbing 56 may be a connector 64 for connecting to a pumping system 60 or pump head 62. A connector may be a nozzle or any other type of connector for plumbing purposes. The plumbing configuration and liquid seed treater system 50 may be incorporated into a hopper 18, which may be attached to a treater framework 16, where the plumbing configuration may be downstream of the top of the hopper 18 opening.

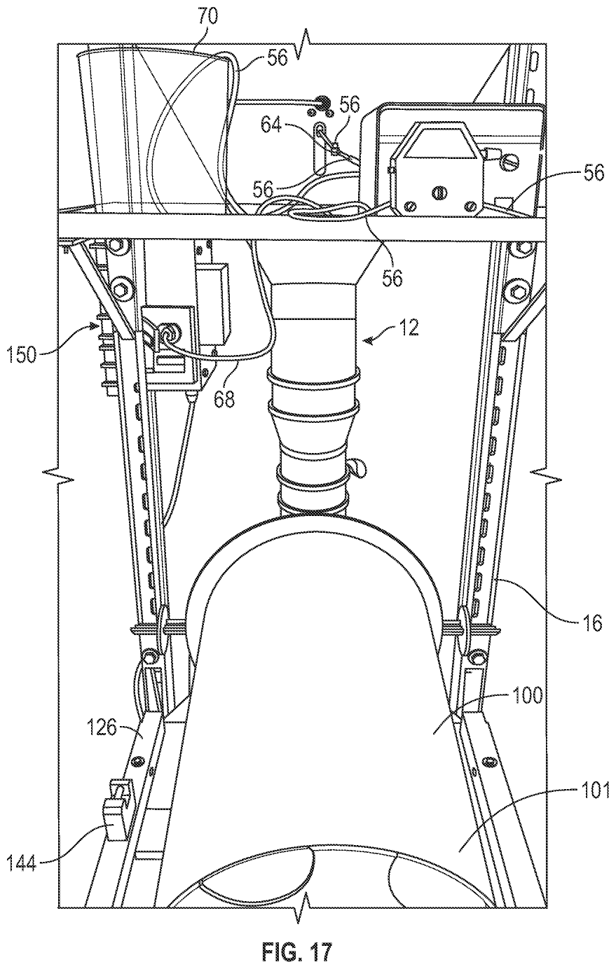

FIG. 17 shows another elevation view of a plumbing configuration of the liquid seed treater system 50 in accordance with an illustrative aspect of the present disclosure. In one aspect, the liquid seed treater system 50 may include peristaltically pumping at least one liquid type of seed treatment to a liquid atomizer located within a seed treatment flow path 12. A pump system 60 may be operably configured to peristaltically deliver at least one liquid type of seed treatment to a discharge or liquid disperser or discharge 58 under operation of a controller 154. The controller 154 may be operatively connected to the control system 150. As shown in FIG. 17, a liquid seed treater system 50 may include a reservoir 70 which may contain a liquid seed treatment, liquid plumbing 56 which may assist in transporting the liquid seed treatment, and a connector 64 which may connect the liquid plumbing 56 to the seed treater 10. The liquid plumbing 56 may be connected to the connector 64 and seed treater 10 through a pump housing 62 of a pump 60 which may peristaltically pump at least one type of liquid seed treatment into the seed treatment flow path 12 of the seed treater 10. A power cable 68 may provide power to the pump 60 which may be controlled by the control system 150. The liquid seed treater system 50 may be supported by the treater framework 16 and be positioned downstream of a valve 36.

Also shown in FIG. 17 is a tumbling system 100, which may include a drum 101, a cradle frame 126, and a sensor 144. The sensor 144 may be a digital angle gauge or a level gauge, and may be affixed to a cradle frame 126 of the cradle and drive system 110 for sensing and indicating the attitude or angle of the cradle and drive system 110. The tumbling system 100 may be supported by the treater framework 16 and may further be controlled by the control system 150.

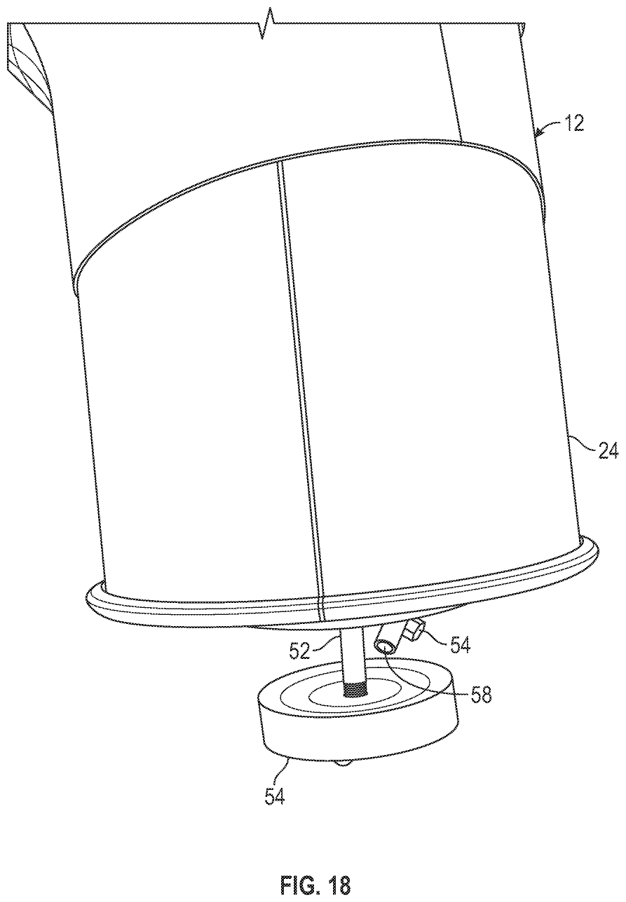

FIG. 18 shows a perspective view of a plumbing configuration and atomizing system in accordance with an illustrative aspect of the present disclosure. A conduit 24 may contain the atomizing system and plumbing configuration in the seed treatment flow path 12. The atomizing system may include a shaft 52, an atomizing wheel 54, liquid plumbing 56, and a discharge 58. An atomizing wheel 54 may be connected to a shaft 52 which may allow the atomizer to rotate at a rate which may be controlled by a controller 154. Liquid plumbing 56 may transport and deliver a liquid, such as a liquid type of seed treatment, to the atomizer wheel 54 at a discharge 58 to be atomized. An atomizing wheel 54 may be a rotary atomizer and may have a variety of different surfaces for atomizing, such as flat, a vaned disc, cup, slotted, or any other conceivable surface that may be utilized in atomizing a liquid. The atomizer may also be a rotary, pressure swirl, twin fluid atomizer, or any other conceivable atomizer or similar mechanism. The atomizing system may be operably configured to receive at least one liquid type of seed treatment from a liquid disperser or discharge 58 for atomizing at least one type of liquid type of seed treatment at an atomizing rate. Further, the atomizing rate may be under the operation of a controller 154 and may also be positioned downstream of a valve 36 on a seed flow path 12.

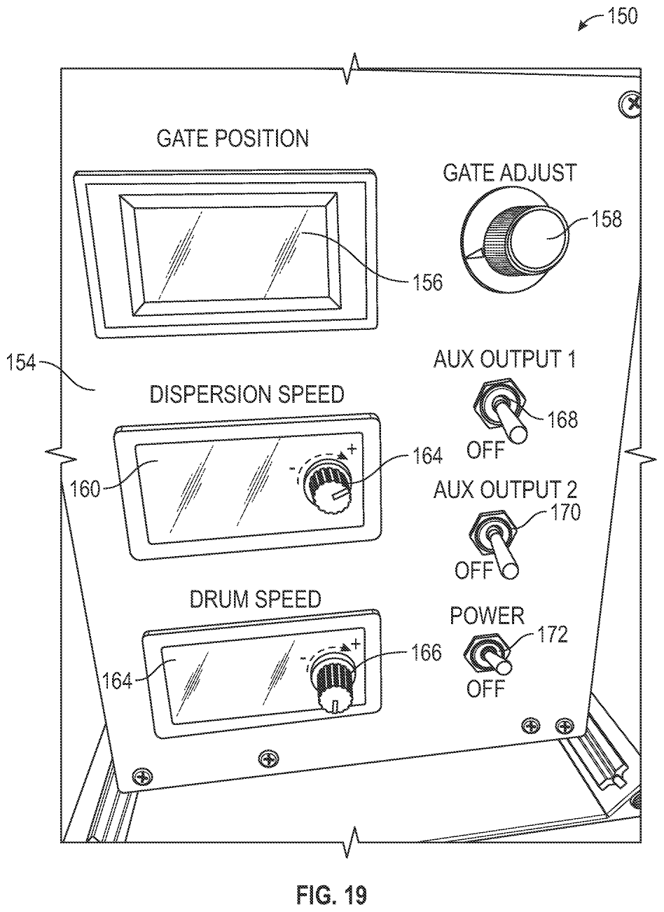

FIG. 19 illustrates a perspective view of a controller 154 of the control system 150 in accordance with an illustrative aspect of the present disclosure. A controller 154 may be configured for electromechanically controlling a rate for seed and seed treatment operations within a seed treatment flow path 12. A controller 154 may also be operably configured to control a seed flow rate, a liquid dispersion rate, and a solid dispersion rate based on at least one or more conditions or operating parameters. The one or more conditions may include, but are not limited to, environment, seed, liquid material, solid material, residue left in the tumbling system 100, and seed treatment. The at least one condition or parameter may include any variety of factors stemming from environment, seed, or seed treatment. Environmental factors or conditions may include but are not limited to ambient or environmental temperature, humidity, barometric pressure, thermal barrier properties, or any other environment that may impact a seed or seed treatment on a seed flow path 12. Seed conditions or characteristics may include but are not limited to seed type, seed sweating, flowability, thermal properties, volume, mass, coat hardness, shape, texture, coat thickness, crude fat, soluble protein, sugar, gibberellins and abscisic acid, adhesiveness, or any other properties of a seed that may require adjustments to the seed flow path 12. Seed treatment factors may include but are not limited to the substances applied to the seed, such as solid or liquid substances, as well as the seed treatment process itself. Factors relating to substances applied to the seed may include but are not limited to ingredients, flowability, drying factors, temperature effects, viscosity, humidity effects, chemical interactions, wettability, or any other factors of relating to the substances that may be used in a seed treater 10 that may require adjustments to the seed flow path 12 or seed treater 10. Factors relating to the seed treatment process itself could be seed flow rate, liquid dispersion rate, solid dispersion rate, tumbling rate, tumbling angle, amount of time in tumbler, amount of residual left over on any components of seed treater 10, or any other factors in the seed treatment process that may require adjustments to the seed flow path 12 or seed treater 10.

The controller 154 may consist of a controller housing 152 and a gate position indicator 156. The gate position indicator 156 may show the gate control direct current (DC) voltage, but other aspects may utilize different units or means to display gate position and/or control information. The controller 154 may include a gate position adjuster 158 and auxiliary output switch(es) 168, 170, and 172. One of the auxiliary output switches may be a main power switch, and other auxiliary output switches may be switches for operating a variety of components of the seed treater 10, including but not limited to a liquid seed treater system 50, a tumbling system 100, or any other conceivable system or mechanism that may be included in the seed treater 10. The gate position adjuster 158 may be used as an infeed gate control of the seed treater 10 to allow for precise and controlled or continuous flow of seed or material. The gate position adjuster 158 may consist of a knob, but other means for adjustment may be used such as a gauge, buttons, switches, touch screen, or other conceivable means of adjustment. The gate position indicator 156 and the gate position adjuster 158 may be used in unison to allow for a replicative and consistent setting for seed flow within a seed flow path 12. The controller 154 or control system 150 may have a communication node or transceiver (not shown) for communicating with remote devices.

The control system 150 and controller 154 may further be configured to electromechanically operate the steps of controlling seed movement in the seed treatment flow path 12 with a valve 36, dispersing at least one liquid type of seed treatment in the seed treatment flow path 12, dispersing at least one solid type of seed treatment in a seed treatment flow path 12, and tumbling the combination with a tumbling system 100.

According to FIG. 19, the controller 154 may also include a dispersion speed adjuster 162 and a drum speed adjuster 166. In conjunction with the atomizer dispersion speed adjuster 162, the controller 154 may include a dispersion speed indicator 160 which may indicate the dispersion speed of a liquid type seed treatment. The dispersion speed may be set using a dispersion speed adjuster 162 to adjust the distribution of at least one liquid or other material(s) onto the seed or other material(s) in the seed treatment flow path 12 via the atomizer 54, however it is contemplated that liquid and the dispersion rate thereof may be dispersed by another means, including but not limited to a spray nozzle, faucet, or other means. The dispersion speed adjuster 162 may consist of a knob, switch, button(s), touch screen, or other conceivable means of control.

In conjunction with the drum speed adjuster 166, the controller 154 may include a drum speed indicator 164 which may indicate the drum speed in rotations per minute (RPM), but other aspects may utilize different units to communicate drum speed. The speed of the drum or mixing chamber 101 of the tumbling system 100 may be controlled using the drum speed adjuster 166 to speed up or slow down the mixing that occurs. The drum speed adjuster 166 may consist of a knob, switch, button(s), touch screen, or other conceivable means of control.

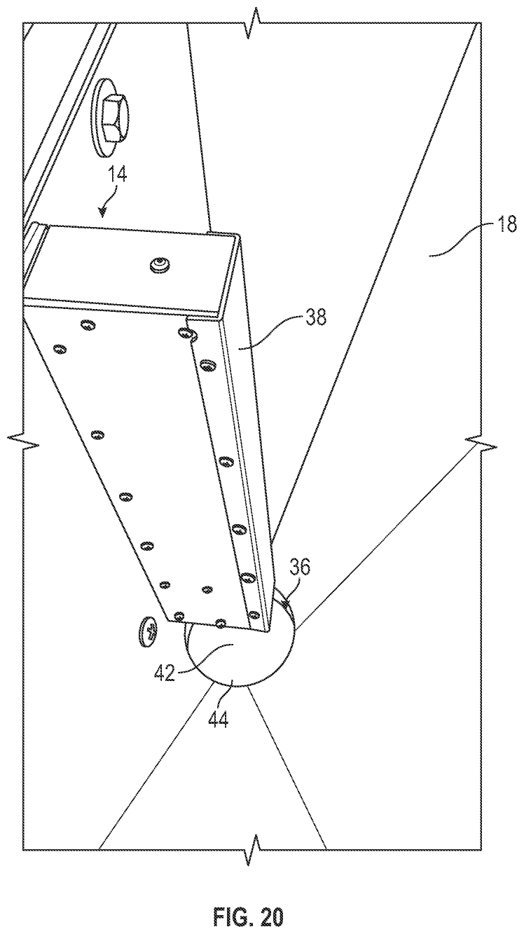

FIG. 20 depicts a top perspective view of actuator system for the seed flow control system 14 in accordance with an illustrative aspect of the present disclosure. The actuator system may include a cover 38. The seed flow control system 14 may further include a valve 36, gate 42, and gate surface 44. The valve 36 in the seed treatment flow path 12 may be utilized to control seed movement, and the valve 36 may include a non-planar gate 42 operably configured for opening and closing a gate opening 46. The gate 42 may be a non-planar gate with a conical shape, but it is also contemplated that a gate 42 could be a variety of shapes and sizes including but not limited to helix, sphere, torus, cylinder, or any other three-dimensional shape to allow passage of materials through a gate opening 46. A gate 42 may also be configured to move in a variety of ways for opening and closing a gate opening, such as vertically, horizontally, rotationally, or any other conceivable means of movement. Further, a gate 42 may be made of metal such as steel or aluminum, but it is contemplated that a gate 42 could be made of a variety of different materials such as other metals, plastics or other carbon-based materials, or any other conceivable material utilizable. It is further contemplated that a gate 42 could be incorporated with a variety of textures or additional openings, including but not limited to grates, holes, ridges, crimps, mesh, or others.

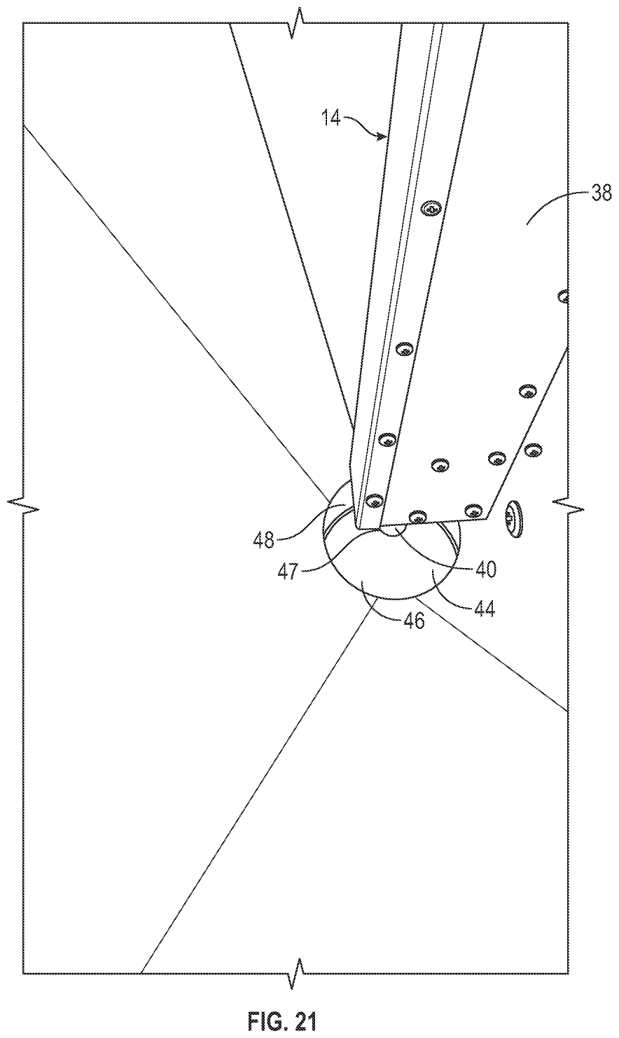

FIG. 21 shows a top perspective view of a valve 36 for the seed flow control system 14 in accordance with an illustrative aspect of the present disclosure. Controlling seed movement in a seed treatment flow path 12 may include a valve 36 which may be equipped to at least move a non-planar surface of a gate 42 through a gate opening 46 for increasing or decreasing an occluded portion of a gate opening 46. A valve 36 may be operably configured to introduce a continuous flow of seed into a seed treatment flow path 12 at a seed flow rate. Further, a valve 36 may control seed movement in a seed flow path 12 in conjunction with a gate 42 which may be configured to have both open and closed positions.

As shown in FIG. 21, a seed flow control system 14 may include a cover 38. The seed flow control system 14 may consist of a plunger 40, a gate surface 44, a gate opening 46, an inner gate surface 47, and an outer gate surface 48. As shown in FIG. 21, a gate 42 may be non-planar or conically shaped. A plunger 40 could be configured to move the gate 42 vertically through a valve 36 which may create an opening for seed or other materials to flow through. Further, the plunger 40 could be configured to be an actuatable plunger via an actuator 39, which could allow the gate to rotate or actuate while also being enabled to move vertically. FIG. 21 shows a gate 42 may be in a more closed position as a plunger 40 may be adjusted to hold the gate 42 in a more closed position, which may cause valve 36 to also be in a closed position.

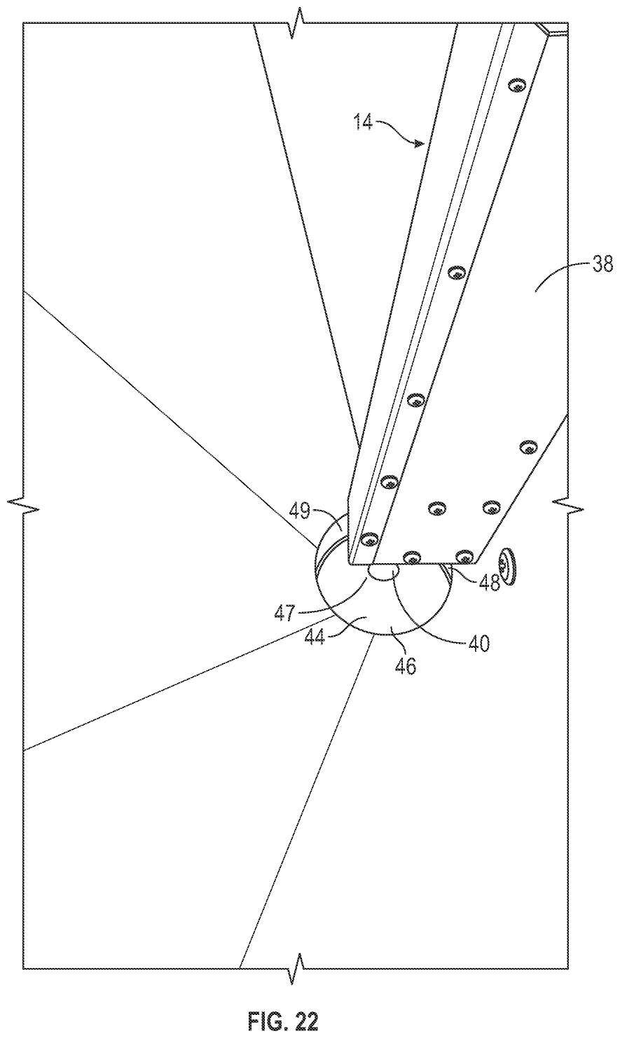

FIG. 22 shows a top perspective view of a gate 42, gate surface 44, and gate opening 46 for the valve 36 for the seed flow control system 14 in accordance with an illustrative aspect of the present disclosure. Still shown in FIG. 22 is a cover 38 for the seed flow control system 14 to protect components of the seed flow control system 14. A gate 42 may be a non-planar gate 42 with an inner gate surface 47 and an outer gate surface 48. A non-planar gate 42 may be conically shaped, and the inner gate surface 47 may be the narrow portion of the conically shaped gate 42 and the outer gate surface 48 may be the wider portion of the conically shaped gate 42. A gate 42 may be connected to a plunger 40 which may assist in controlling the vertical position of gate 42 to either a predominantly open or closed position. As shown in FIG. 22, a gate gap 49 may be created when a gate 42 is positionally moved, in the present aspect by a plunger 40, to create space in a gate opening 46 to allow passage of seed or other materials through the valve 36. Still further shown, FIG. 22 illustrates a gate 42 may be in a predominantly open position as a plunger 40 may be adjusted to hold the gate 42 in a predominantly open position, which may cause valve 36 to also be predominantly open. Though a plunger 40 is shown in FIG. 22 to assist in adjusting the position of gate 42, it is contemplated that gate 42 could be positionally adjusted by a variety of means.

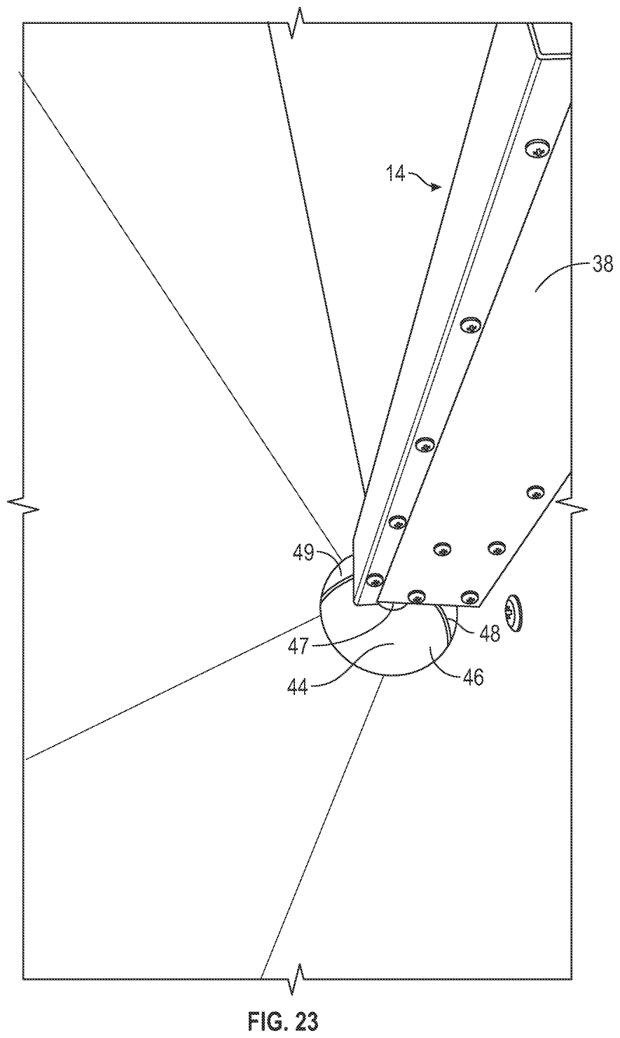

FIG. 23 shows another top perspective view of a gate 42, gate surface 44, and gate opening 46 for the valve 36 for the seed flow control system in accordance 14 with an illustrative aspect of the present disclosure. Also shown in FIG. 23 is a cover 38 which may be included in the seed flow control system 14 along with a gate opening 44 where a gate may be positioned to allow a valve 36 to be increasingly or decreasingly occluded for the passage of seed or other materials through the seed flow control system 14 and into a seed flow path 12. The gate 42 may be a non-planar shape, such as a cone, and may include a gate surface 44, an inner gate surface 47 near the inner portion of the cone shape and an outer gate surface 48 near the outer portion of the cone shape. Further shown in FIG. 23 is a gate gap 49 which may be created by controlling movement or position of a gate 42. The movement or position of a gate 42 may be controlled by a plunger 40 or an actuator 39, and the gate 42 may be moved or positioned in various ways including but not limited to vertically, horizontally, rotationally, or any other conceivable ranges of motion. Actuator 39 maybe a linear actuator which may be operably configured to actuate a non-planar surface, such as a gate 42, through a gate opening 46 of a valve 36. Further, an actuator 39, gate 42, and gate components may be under operation of a controller 154 for controlling a seed flow rate. A gate 42 may be predominantly in an open or closed position, or a partially open or closed position, as illustrated in FIG. 23. According to at least one aspect and FIGS. 21 through 23, at least a portion of a non-planar gate 42 may be disposed within a gate opening 46 in both a closed and open position of a non-planar gate 42.

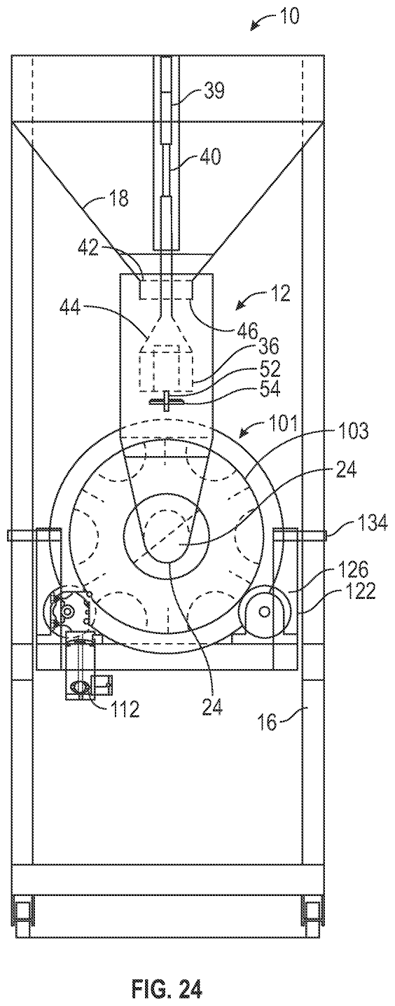

FIG. 24 illustrates an end elevation view of a seed treater 10 and seed flow control system 14 in accordance with an illustrative aspect of the present disclosure. A treater framework 16 may support a seed treater 10. An actuator 39 may be connected to a plunger 40 within a seed hopper 18. A seed hopper 18 may include a gate 42 and gate opening 46 to allow seed or other materials to pass through to a seed flow path 12. The gate 42 may be in a predominantly open or predominantly closed position as a plunger 40 and an actuator 39 may raise or lower the gate surface 44 through a gate opening 46. An actuator 39 may be a linear actuator, though it is contemplated that other types of actuators may be utilized to achieve movement of a gate 42, including but not limited to rotary, hydraulic, mechanical, electrical, pneumatic, or others. A predominantly open position of gate 42 may allow seed or other materials to pass through a valve 36 on a seed flow path 12, whereas a predominantly closed position of gate 42 may prevent seed or other materials to pass through a valve 36. An actuator 39 may be under operation of a controller 154.

A shaft 52 and atomizing wheel 54 may be included in the seed treatment flow path 12, and atomizing wheel 54 may be connected to a shaft 52 which may allow the atomizer to rotate at a rate which may be controlled by a controller 154. Liquid plumbing 56 may transport and deliver a liquid, such as a liquid type of seed treatment, to the atomizing wheel 54 at a discharge 58 to be atomized. An atomizing wheel 54 may be a rotary atomizer and may have a variety of different surfaces for atomizing, such as flat, a vaned disc, cup, slotted wheel, or any other conceivable surface that may be utilized in atomizing a liquid. The atomizer may also be a rotary, pressure swirl, twin fluid atomizer or any other conceivable atomizer or similar mechanism. As illustrated in FIG. 24, an atomizing wheel 54 may be positioned downstream of a valve 36, and may help facilitate the dispersion of a liquid, such as a liquid type of seed treater, into a seed flow path 12. As further illustrated in FIG. 24, a liquid atomizer 54 within a seed flow path 12 may receive at least one liquid type of seed treatment from a liquid disperser 58 for atomizing at least one liquid type of seed treatment within a seed treatment flow path 12, and may also be positioned downstream of a valve 36.

A tumbling system 100 and drum 101 may also be included in a seed treater 10. A conduit 24 may assist in conveying seed and seed treatment on a seed treatment flow path 12 to a drum 101 of a tumbling system 100. A drum 101 may be an actuatable housing within a seed treatment flow path 12 and may be positioned downstream of a valve 36 controlling seed movement. A drum 101 may have an outer surface, and may include baffles 104 for further controlling seed movement along a seed flow path 12. A drum 101 may be positioned on rollers 122 which may be incorporated on a cradle frame 126. The rollers 122 and cradle frame 126 may be utilized to allow a drum 101 to rotate or actuate through a motor/actuator 112 which may facilitate rotation.

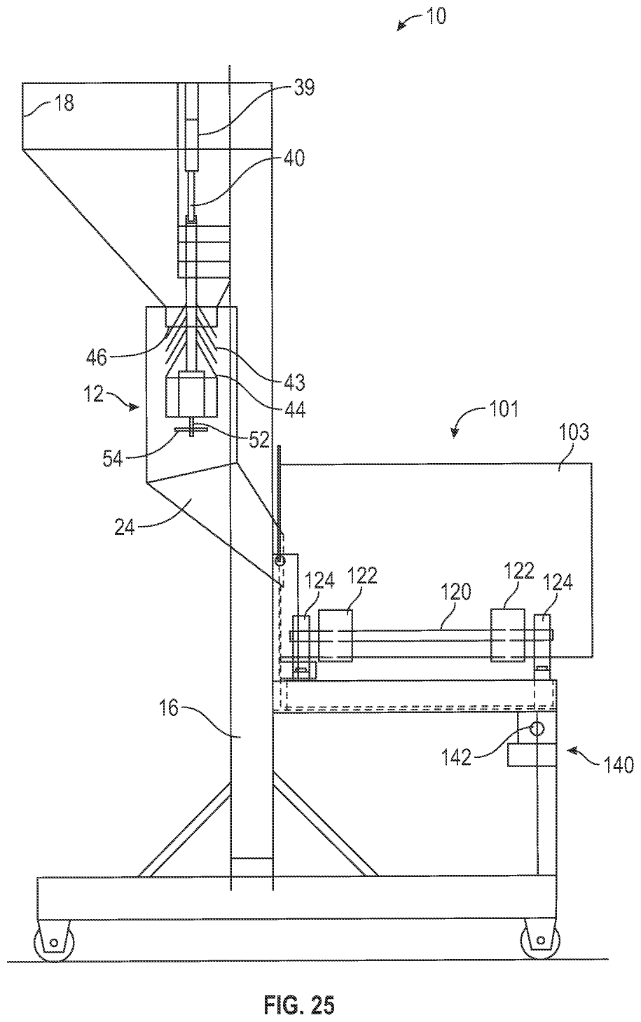

FIG. 25 depicts a side elevation view of a seed treater 10 and seed flow control system 14 in accordance with an illustrative aspect of the present disclosure. A treater framework 16 may support the seed treater 10 and all components. An actuator 39 may be operably connected to a plunger 40 within a seed hopper 18. A seed hopper 18 may include a gate opening 46 which may allow a gate 42 to increase or decrease occlusion of a gate opening 46. A gate 42 may have a gate surface 44 and may also be operably attached to a plunger 40 and actuator 39, which may further be configured to control the position of the gate 42 through a gate opening 46 to achieve various gate positions 43. Gate positions 43 may include but are not limited to closed, open, partially closed, partially open, predominantly closed, predominantly open, or any other conceivable position to allow seed to continue on a seed treatment flow path 12. An actuator 39 may be under the operation of a controller 154 to control the position of the gate 42. As shown in FIG. 25, a gate 42 may be a non-planar gate with a conical shape, but it is also contemplated that a gate 42 could be a variety of shapes and sizes including but not limited to helix, sphere, torus, cylinder, or any other three-dimensional shape to allow passage of materials through a gate opening 46.

An atomizing wheel 54 and shaft 52 may be located downstream of a valve 36 in a seed treatment flow path 12, as shown in FIG. 25. An atomizing wheel 54 may be connected to a shaft 52 which may allow the atomizer to rotate at a rate which may be controlled by a controller 154. Liquid plumbing 56 may transport and deliver a liquid, such as a liquid type of seed treatment to the atomizer wheel 54 at a discharge 58 to be atomized. An atomizing wheel 54 may be a rotary atomizer and may have a variety of different surfaces for atomizing, such as flat, a vaned disc, cup, slotted wheel, or any other conceivable surface that may be utilized in atomizing a liquid. The atomizer may also be a rotary, pressure swirl, twin fluid atomizer or any other conceivable atomizer or similar mechanism. An atomizing wheel 54 may be utilized to disperse at least one liquid type of seed treatment in the seed treatment flow path 12 downstream of a valve 36, but it is contemplated that other means of liquid dispersion may be utilized, including but not limited to nozzles, ultrasonic nozzles, faucets, spray heads, pressure sprayers, centrifugal sprayers, electrostatic sprayers, or any other means of dispersing liquid.

A conduit 24 may channel seed and seed treatment materials on a seed treatment flow path 12 to a drum 101 of a tumbling system 100. A drum 101 may include an outer surface 103 and may be supported on a cradle frame 126. A shaft 120 may be connected to bearings 124 on a cradle frame 126, and a shaft 120 may be inserted through rollers 122 which hold the drum 101. The rollers 122 may enable the drum 101 to rotate or actuate. In the present aspect, rollers 122 may be cylindrical in shape, but it is contemplated that the rollers may consist of any other shape that may allow a supported object a range of motion or rotation. Other roller shapes may include but are not limited to spheres, cones, coils, or any other shape conceivable for allowing movement. Seed and seed treatment may continue along a seed treatment flow path 12 through drum 101 which may further combine seed and seed treatment downstream of a valve 36.

A tilt control system 140 may also be included in the seed treater 10. As shown in FIG. 25, a tilt control system may be positioned or affixed to a cradle and drive system 110 on a cradle frame 126. A tilt control system 140 may be operably configured to control the attitude of the seed treatment flow path 12, and may adjust the tilt or position of the drum 101 of the tumbling system 100. The tilt control system 140 may include an actuator 142 to adjust the attitude or tilt of the system. As shown in FIG. 25, an actuator 142 may be a scissor jack, but it is contemplated that various types of actuators may be utilized to adjust attitude.

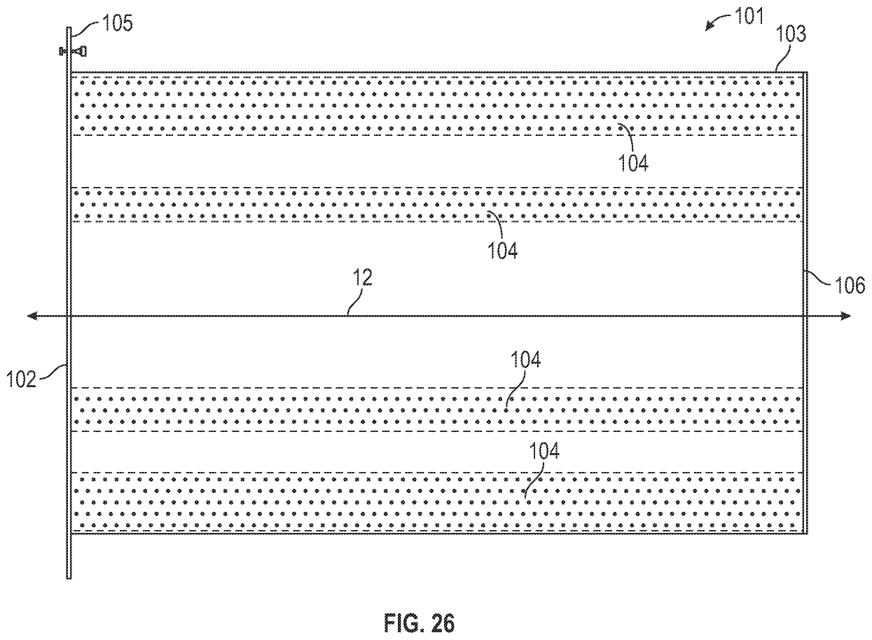

FIG. 26 shows a top view of a drum or tumbler 101 in accordance with an illustrative aspect of the present disclosure. A tumbler 101 may include an outer surface 103 and openings 102 and 106. The openings 102 and 106 may receive seed and seed treatment along the seed treatment flow path 12 for passage through the tumbler 101. Opening 102 may receive seed and seed treatment and may be connected to a conduit 24, whereas opening 106 may discharge combined seed and seed treatment. Openings 102 and 106 may also be utilized to provide ventilation for a drum 101 and may be the openings through which the seed treatment flow path 12 travels. A tumbler 101 may be operably configured to assist in combining seed and seed treatment within the seed treatment flow path 12 at a tumbling rate, and a controller 154 may be operably configured to control the tumbling rate of the drum or tumbler 101.

As shown in FIG. 26, a tumbler 101 may include baffles 104 which may further assist in tumbling a combination of seed, at least one liquid type of seed treatment, and at least one solid type of seed treatment within the seed flow path 12. While baffles 104 may be used as shown in FIG. 26, a tumbler 101 may be contemplated to utilize ridges, heating/cooling elements, sensors, ventilators, discharges, gates, grates, textures or any other conceivable mechanism or design that can be utilized in conjunction with a tumbler 101 for a variety of purposes. It may be further contemplated that the tumbler 101 be made of steel, aluminum, plastic, or any other type of material suitable for mixing materials. Further still, it is contemplated that baffles 104 may consist of a variety of materials such as metals, plastics, rubber, carbon-based materials, or others, and it is also contemplated that baffles 104 may include a variety of textures or surfaces such as grates, holes, ridges, crimps, fabrics, or other such characteristics that may further alter the tumbling of seed and seed treatment within a drum or tumbler 101. A tumbler 101 may also include a flange 105 which may be used for attaching a tumbler 101 to a frame such as seed treater frame 16 or cradle frame 126.

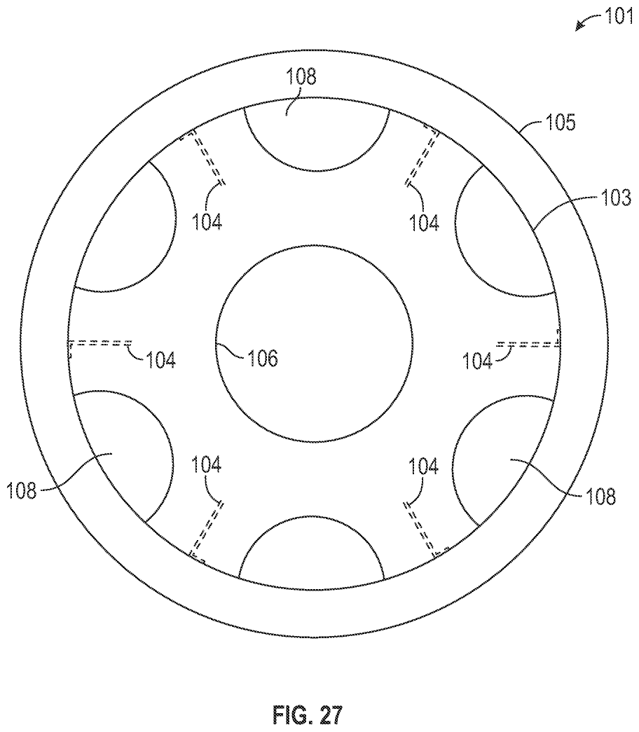

FIG. 27 illustrates an end view of a tumbler 101 in accordance with an illustrative aspect of the present disclosure. As shown in FIG. 27, a tumbler 101 may include an outer surface 103 and a flange 105 for attaching a tumbler 101 to a frame or other supporting element or mechanism. Baffles 104 may be included within the tumbler 101 to further assist in combining seed and seed treatment along a seed treatment flow path 12. Opening 106 may be a large opening at the end of a tumbler 101 and may be utilized for discharging materials from the tumbler 101, and opening 106 may be positioned centrally on the end of the tumbler 101. As shown in FIG. 27, opening 106 may be circular in shape, but it is contemplated that other shapes and sizes may be utilized as an opening 106. Additional openings 108 may be positioned around the circumference of an end of a tumbler 101, and may be utilized for ventilation or further discharging materials from the tumbler 101. Openings 108 may be half circles, but it is contemplated that various other shapes may be utilized as openings 108.

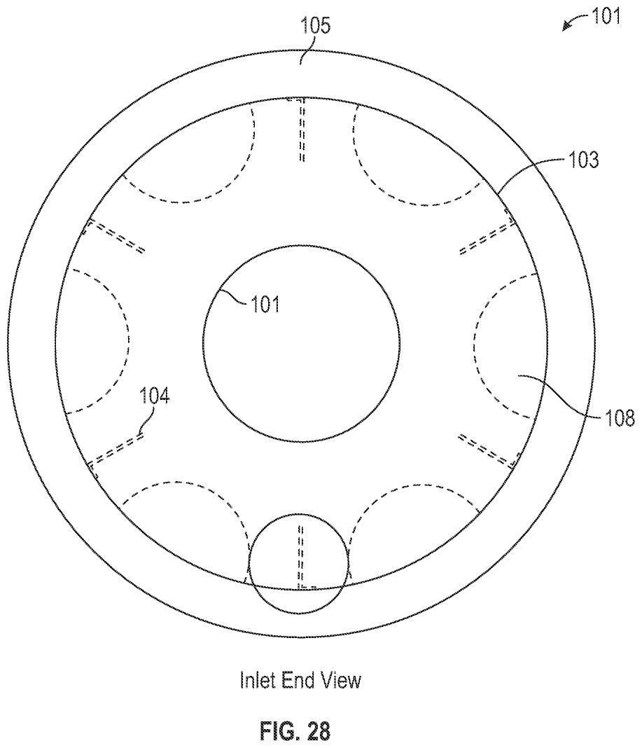

FIG. 28 shows another end view of a tumbler 101 in accordance with an illustrative aspect of the present disclosure. As shown, a tumbler 101 may include an outer surface 103 and a flange 105 for attaching a tumbler 101 to a frame or other supporting element or mechanism. Baffles 104 may be included within the tumbler 101 to further assist in combining seed and seed treatment along a seed treatment flow path 12. Opening 102 may be a large opening at the end of a tumbler 101 and may be utilized for channeling materials into the tumbler 101, and opening 102 may be positioned centrally on the end of the tumbler 101. As shown in FIG. 27, opening 102 may be circular in shape, but it is contemplated that other shapes and sizes may be utilized as an opening 102. Additional openings 108 may be positioned around the circumference of an end of a tumbler 101, and may be utilized for ventilation for materials being combined in the tumbler 101. Openings 108 may be half circles, but it is contemplated that various other shapes may be utilized as openings 108.

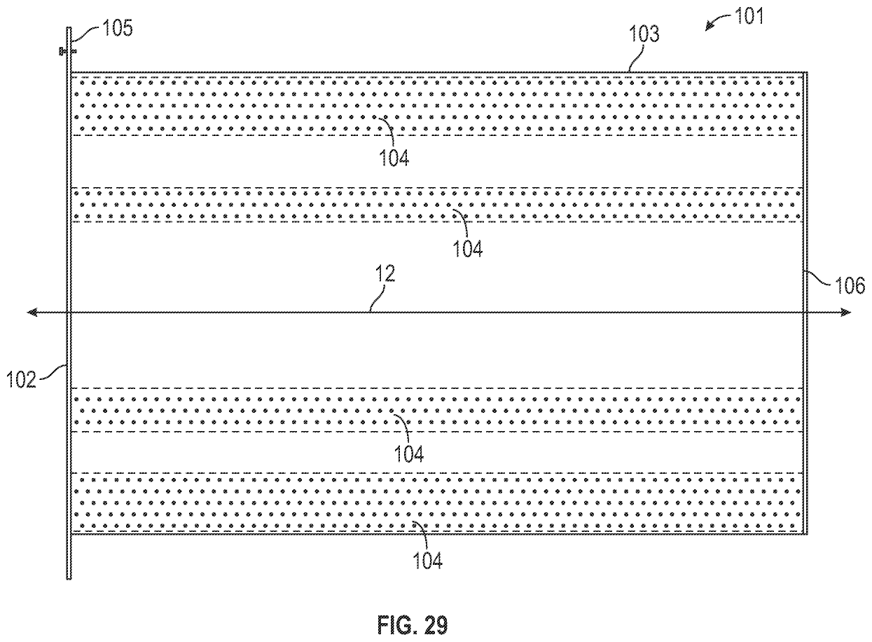

FIG. 29 shows another side view of a tumbler 101 in accordance with an illustrative aspect of the present disclosure. A tumbler 101 may include an outer surface 103 and openings 102 and 106. The openings 102 and 106 may receive seed, liquid material, solid material, and seed treatment along the seed treatment flow path 12 for passage through the tumbler 101. However, opening 102 may be an inlet opening to introduce seed and seed treatment into a tumbler 101, and opening 106 may be an outlet for discharging a combination of seed and seed treatment from a tumbler 101 of seed treater 10. A tumbler 101 may be operably configured to assist in combining seed and seed treatment within the seed treatment flow path 12 at a tumbling rate, and a controller 154 may be operably configured to control the tumbling rate of the drum or tumbler 101. A seed treatment flow path 12 may be positioned centrally within the tumbler 101 and follow through the length of tumbler 101. However, a seed treatment flow path 12 is contemplated to follow an alternate route if a tumbler 101 may be a different size, shape, or have varying internal components that alter the seed treatment flow path 12.

A shown in FIG. 29, a tumbler 101 may include baffles 104 which may further assist in tumbling a combination of seed, at least one liquid type of seed treatment, and at least one solid type of seed treatment within the seed flow path 12. While baffles 104 may be used as shown in FIG. 29, a tumbler 101 may be contemplated to utilize ridges, heating/cooling elements, sensors, ventilators, discharges, gates, grates, textures or any other conceivable mechanism or design that can be utilized in conjunction with a tumbler 101 for a variety of purposes. It may be further contemplated that the tumbler 101 be made of steel, aluminum, plastic, or any other type of material suitable for mixing materials. Further still, it is contemplated that baffles 104 may consist of a variety of materials such as metals, plastics, rubber, carbon-based materials, or others, and it is also contemplated that baffles 104 may include a variety of textures or surfaces such as grates, holes, ridges, crimps, fabrics, or other such characteristics that may further alter the tumbling of seed and seed treatment within a drum or tumbler 101. A tumbler 101 may also include a flange 105 which may be used for attaching a tumbler 101 to a frame such as seed treater framework 16 or cradle frame 126.

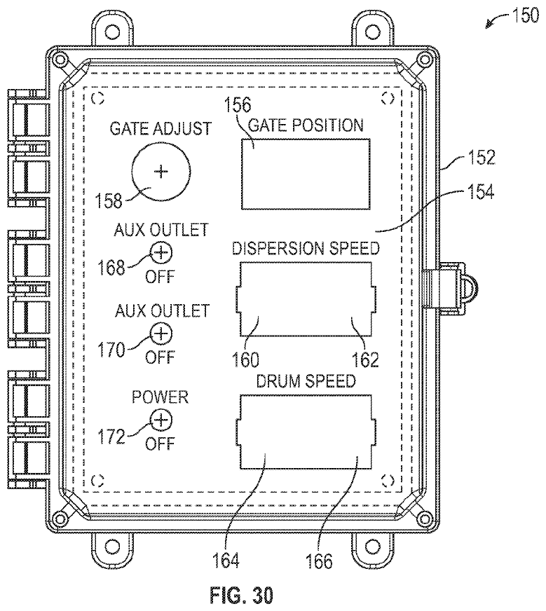

FIG. 30 illustrates a front view of a controller 154 and controller housing 152 in accordance with an illustrative aspect of the present disclosure. The controller 154 may be a part of the controller system 150 and may be enclosed in the controller housing 152. The controller 154 within the controller housing 152 may be removably attached to the seed treater 10 by means of mounts or holes for attachment or removability. The controller housing 152 may also be opened by means of a latch, door and hinges, clasps, hooks, belt and loops, fasteners, or other conceivable means of removability or openability.

Further shown in FIG. 30, the controller 154 may include a gate position adjuster 158 and a gate position indicator 156 for displaying the gate control direct current (DC) voltage, but other aspects may utilize different units or means to display gate position and/or control information. The gate position adjuster 158 may be used for the infeed gate control of the seed treater 10 to allow for precise and controlled flow of seed or material. The gate position adjuster 158 may consist of a knob, but other means for adjustment may be used such as a gauge, buttons, switches, touch screen, or other conceivable means of adjustment. The gate position indicator 156 and the gate position adjuster 158 may be used in unison to allow for replicative consistent setting of seed flow along a seed flow path 12. The controller 154 may also include one or more auxiliary output switches 168, 170, and 172 which may be utilized to provide power to a pump 60 and/or seed mixing equipment or tumbling system 100. The auxiliary output switches 168, 170, and 172 may be flip switches, knobs, buttons, touch screen, or other conceivable means for providing power or operating components of seed treater 10. Further, the auxiliary output switches 168, 170, and 172 may be utilized to adjust, control, or provide power to different parts or mechanisms of the seed treater 10. Auxiliary output switch 172 may be a main power switch to provide power to any and/or all components or mechanisms of the seed treater 10, and may consist of a knob, switch, button(s), touch screen, or other conceivable means of providing power.

Still further shown in FIG. 30, the controller system 150 may include a dispersion speed adjuster 162 and a drum speed adjuster 166. In conjunction with the dispersion speed adjuster 162, the controller 150 may include a dispersion speed indicator 160 which may indicate the dispersion speed in. The dispersion speed adjuster 162 may consist of a knob, switch, button(s), touch screen, or other conceivable means of control. In conjunction with the drum speed adjuster 166, the controller 150 may include a drum speed indicator 164 which may indicate the drum speed in rotations per minute (RPM), but other aspects may utilize different units to communicate drum speed. The drum speed adjuster 166 may consist of a knob, switch, button(s), touch screen, or other conceivable means of control.

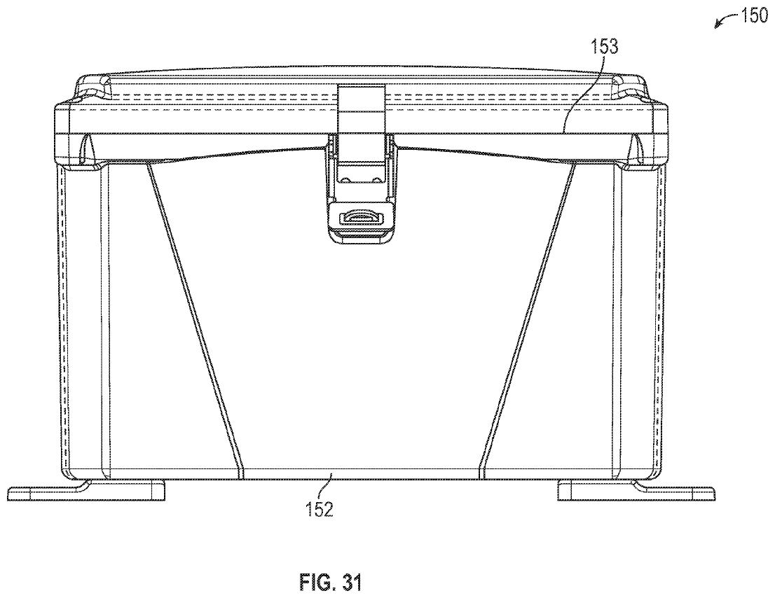

FIG. 31 illustrates a side view of a controller 154 and controller housing 152 in accordance with an illustrative aspect of the present disclosure. As shown in FIG. 31 and as part of the controller system 150, the controller housing 152 may include a door or opening 153 which may be removable or otherwise opened by means of a latch, hinges, clasps, hooks, belt and loops, fasteners, or other conceivable means of removability or openability.

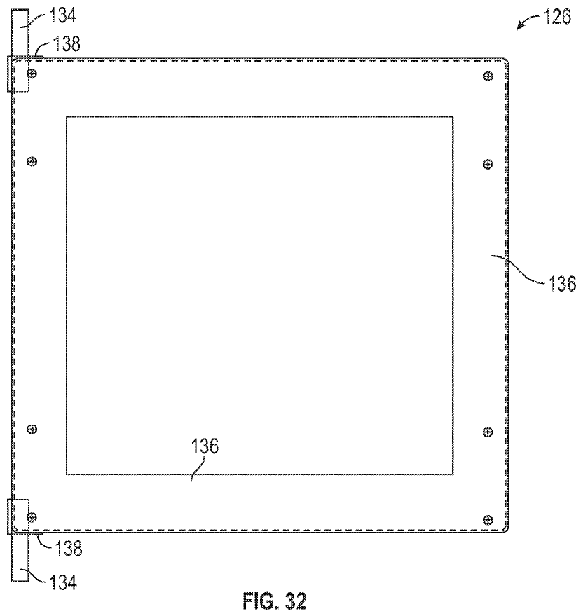

FIG. 32 shows a top view of a treater framework 126 in accordance with an illustrative aspect of the present disclosure. A treater framework or cradle frame 126 may be utilized for a cradle and drive system 110, and may include frame members 136 for supporting components of a cradle and drive system 110. The members 136 may form a predominantly square shape, but other shapes may be utilized to support components of either a cradle and drive system 110 or other components of a seed treater 10. A treat framework 126 may include posts 138 which may be arranged vertically to support a drum 101 as well as mounting arms or drum pivots 134 which may be utilized for attaching a drum 101 to the frame or otherwise supporting a drum 101.

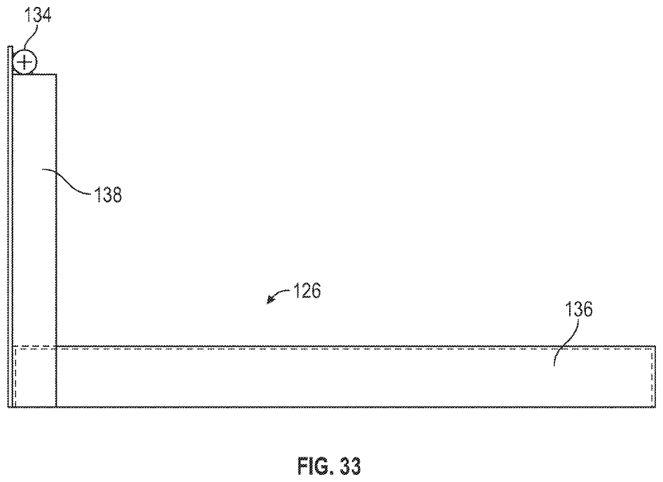

FIG. 33 illustrates a side view of a treater framework 126 in accordance with an illustrative aspect of the present disclosure. As shown, treater framework or a cradle frame 126 may include frame members 136 that may extend outwardly from posts 138 to form an “L” shape as depicted from the side as shown in FIG. 33. Mounting arms or drum pivots 134 may be utilized to support drum 101 on the treater framework 126 in conjunction with the posts 138.

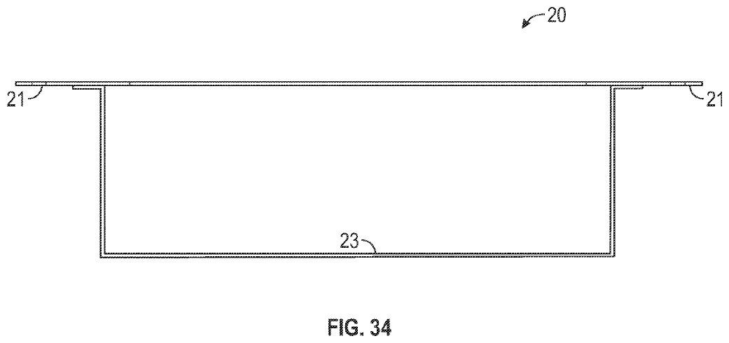

FIG. 34 shows an end view of a treater framework 16 or 126 in accordance with an illustrative aspect of the present disclosure. A treater framework 16 or 126 may include a cover 20 which may further include an outer panel 23. A cover 20 or outer panel 23 may be removable from the treater framework 16 or 126. Additionally, a treater framework 16 or 126 may include adjustment slots 21 for adjusting position of a cover 20 and/or outer panel 23.

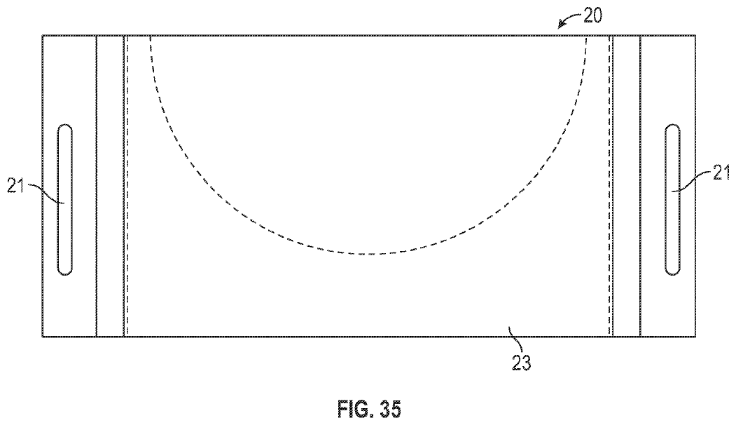

FIG. 35 shows another end view of a treater framework 16 or 126 in accordance with an illustrative aspect of the present disclosure. A treater framework 16 or 126 may include a cover 20 which may further include an outer panel 23. A cover 20 or outer panel 23 may be removable from the treater framework 16 or 126. Additionally, a treater framework 16 or 126 may include adjustment slots 21 for adjusting position of a cover 20 and/or outer panel 23.

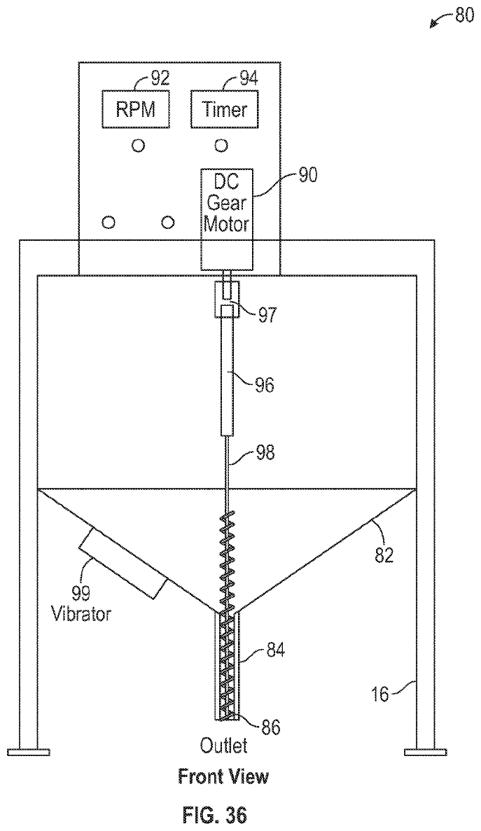

FIG. 36 depicts a front elevation view of a solid seed treater system 80 and control system 88 in accordance with an illustrative aspect of the present disclosure. A solid seed treater system 80 may be attached to or supported by a treater framework 16 and may be a solid conveyor operably configured to convey at least one solid type of seed treatment to a solid disperser, outlet, or opening 86. As shown in FIG. 36, a solid seed treater system 80 may include a hopper 82 which may receive a solid seed treatment for conveyance through a conduit 84 and an opening or outlet 86. The outlet 86 may be utilized to disperse at least one solid type of seed treatment in the seed treatment flow path 12 downstream of a valve. A shaft 96 may be connected to an auger 98 for conveying at least on solid type of seed treatment to a solid disperser disposed within the seed treatment flow path 12, and the shaft 96 may be operably connected to a coupler 97, where a coupler 97 may be connected to a motor 90 which may be operated by a controller 88. A motor 90 may be a DC gear motor and may operably enable rotation of the shaft 96 and auger 98 to convey at least one solid seed treatment through a hopper 82 and conduit 84 for dispersion at an opening 86.

Controller 88 may include controls 92 and 94, which may include a timer and a rotation speed adjuster for adjusting the rate of rotation of the auger 98. The rotation rate may be calculated and indicated in rotations per minute (RPM). As shown in FIG. 36, a solid seed treater system 80 may be operably configured to introduce at least one solid type of seed treatment into a seed treatment flow path 12 at a solid dispersion rate. Further shown in FIG. 36, a solid seed treater system 80 may include a vibrator 99 which may be utilized to further assist conveying at least one type of solid seed treatment from the hopper 82 through a conduit 84 for dispersion at an opening 86.

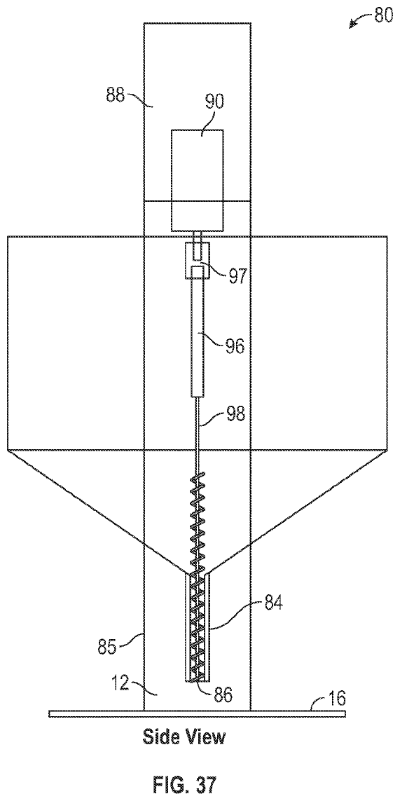

FIG. 37 illustrates a side elevation view of a solid seed treater system 80 and control system 88 in accordance with an illustrative aspect of the present disclosure. As previously described, a solid seed treater system 80 may be attached to or supported by a treater framework 16, and could include a motor 90, coupler 97, shaft 96, and auger 98 which may be operably connected and utilized to convey at least one type of solid seed treatment through a conduit 84 and 85 for dispersion at an opening 86 onto a seed treatment flow path 12. The dispersion rate of solid seed treatment through the solid seed treater system 80 may be controlled by a controller 88, which may include controls 92 and 94 to control the rotation rate of an auger 98 powered by a motor 90, and therefore control the dispersion rate of an at least one type of solid seed treatment onto a seed treatment flow path 12.

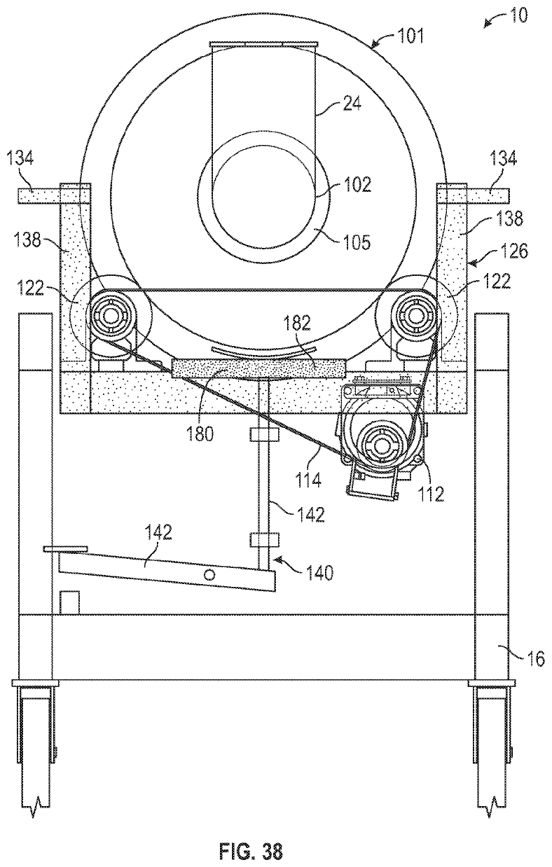

FIG. 38 shows an end elevation view of a cradle and drive system 110 and tilt controller system 140 in accordance with an illustrative aspect of the present disclosure. A cradle and drive system 110 may be attached to or supported by a cradle frame 126, and a cradle frame 126 may include posts 138 along with mounting arms or drum pivots 134 for supporting components of the cradle and drive system 110 as well as a tumbler or drum 101 of a tumbling system 100. A cradle and drive system 110 may further be attached to or supported by a treater framework 16. Rollers 122 may be operably configured and connected to a motor/actuator 112 which may control a drive member 114, allowing rollers 122 to rotate and therefore allow a drum 101 to rotate. The rotation of a drum 101 may be utilized to further tumble the combination of seed, liquid seed treatment, and solid seed treatment along a seed treatment flow path 12.

A tilt control system 140 may include an actuator 142, which may be a scissor jack or other mechanism which may be used to adjust attitude. A tilt control system 140 may also incorporate a weighing system 180 which may be operably configured to weigh residual seed treatment within the seed treatment flow path 12 from receiving seed and seed treatment and discharging a combination of seed and seed treatment. A weighing system could include a sensor 182 which may be a load sensor. As shown in FIG. 38, a weighing system 180 may be positioned beneath a tumbling system 100 and drum 101 to accurately weigh the contents of a drum 101. In one aspect, the tilt control system 140 may be operatively connected to the controller 154 or control system 150.

A drum 101 may include an opening 102 which may be an inlet or infeed opening for receiving a combination of seed and seed treatment. A flange 105 may be used to connect a conduit 24 to the opening 102 of the drum 101 to assist in conveying the combination of seed and seed treatment into the drum 101 on a seed treatment flow path 12.

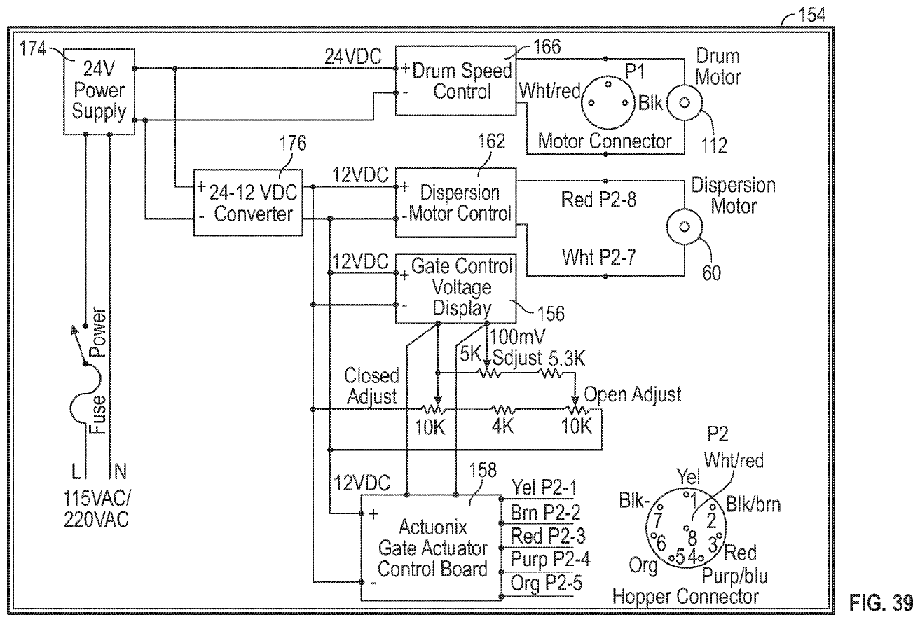

FIG. 39 illustrates a control circuit schematic 154 for a seed treater 10 in accordance with an illustrative aspect of the present disclosure. A control circuit 154 may also include a power supply 174 which may be a 24V power supply or any other appropriate voltage. A control circuit 154 may further include a 24-12 volts of direct current (VDC) voltage converter 176 or any other appropriate VDC converter. The control circuit 154 may also include a gate position adjuster 158, a gate position indicator 156, a dispersion speed adjuster 162, and a drum speed adjuster 166. Further, the control circuit 154 may include a drum motor 112 and a dispersion motor for pump 60.

FIG. 40 shows a flowchart illustrating a seed treatment method in accordance with an illustrative aspect of the present disclosure. A seed treatment method may include the step 200 of providing a seed treatment flow path for receiving seed and seed treatment and discharging a combination of seed and seed treatment. Further, a seed treatment method may include the step 202 of providing a seed flow control valve for controlling the continuous and consistent flow of seed through the seed treatment flow path. A seed treatment method may also include the step 204 of dispersing at least on liquid type of seed treatment into the seed treatment flow path and step 206 of dispersing at least on solid type of seed treatment into the seed treatment flow path. Additionally, a seed treatment method may include the step 208 of tumbling the combination of seed, at least on liquid type of seed treatment, and at least one solid type of seed treatment within the seed treatment flow path. Further still, a seed treatment method may include the step 210 of controlling the continuous and consistent flow of seed into the seed treatment flow path based on at least on condition, and may further include the step 212 of controlling the dispersing of at least one liquid type of seed treatment into the seed treatment flow path based on at least on condition. Further shown in FIG. 40 is the step 214 of controlling the dispersing of at least one solid type of seed treatment into the seed treatment flow path based on at least one condition, as well as the step 216 of controlling the tumbling of the combination within the seed treatment flow path based on at least one condition.

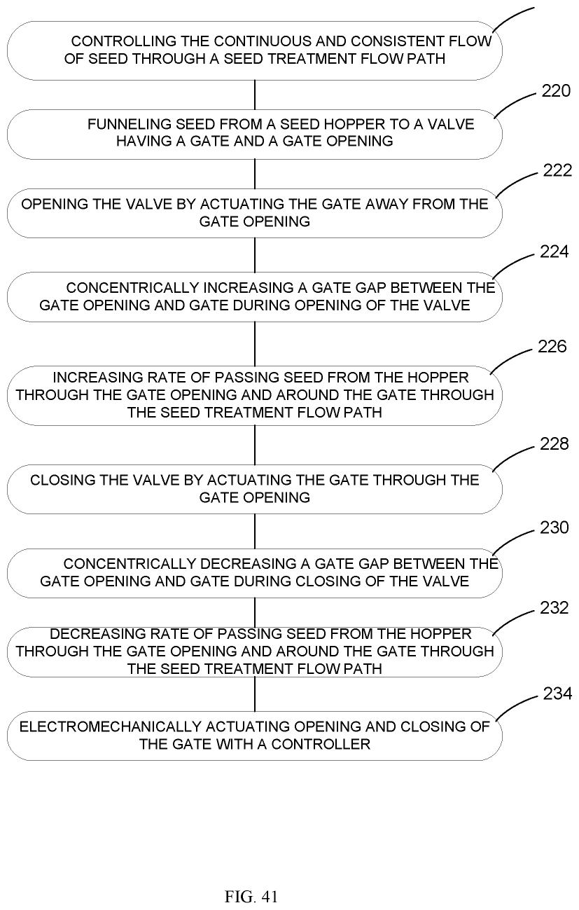

FIG. 41 shows another flowchart illustrating a seed treatment method in accordance with an illustrative aspect of the present disclosure. A seed treatment method may include the step 218 of controlling the continuous and consistent flow of seed through a seed treatment flow path. Further, a seed treatment method may include the step 220 of funneling seed from a seed hopper to a valve having a gate and a gate opening, and also include the step 222 of opening the valve by actuating the gate away from the gate opening. Further still, a seed treatment method may include the step 224 of concentrically increasing a gate gap between the gate opening and gate during opening of the valve, and the step 226 of increasing the rate of passing seed from the hopper through the gate opening and around the gate through the seed treatment flow path. FIG. 41 further shows the step 228 of closing the valve by actuating the gate through the gate opening. As shown further in FIG. 41, a seed treatment method may include the step 230 of concentrically decreasing a gate gap between the gate opening and gate during closing of the valve, as well as the step 232 of decreasing the rate of passing seed from the hopper through the gate opening and around the gate through the seed treatment flow path. FIG. 41 also shows the step 234 of electromechanically actuating the opening and closing of the gate with a controller.

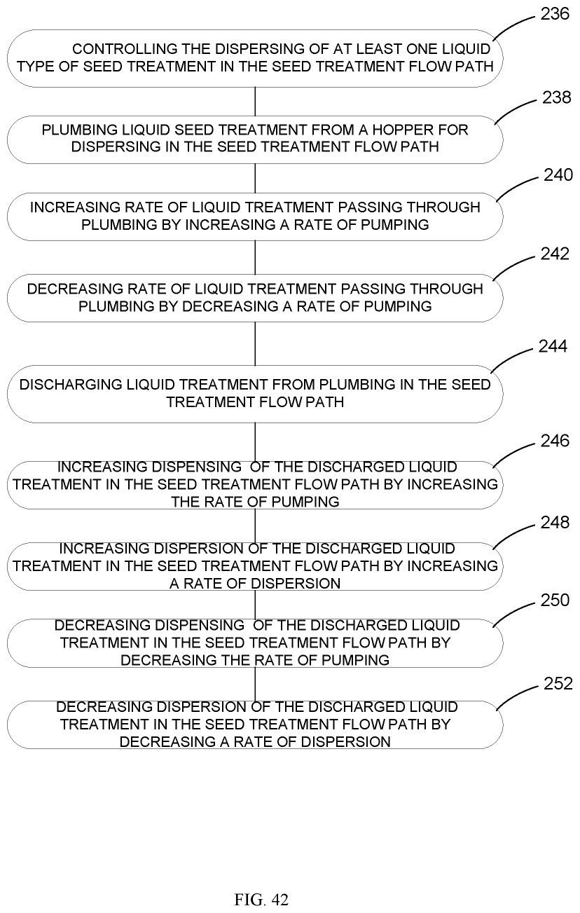

FIG. 42 shows yet another flowchart illustrating a seed treatment method in accordance with an illustrative aspect of the present disclosure. A seed treatment method may include the step 236 of controlling the dispersing of at least one liquid type of seed treatment in the seed treatment flow path. A seed treatment method may also include the step 238 of plumbing liquid seed treatment form a hopper for dispersing in the seed treatment flow path. As further shown in FIG. 42, a seed treatment method may also include the step 240 of increasing the rate of liquid treatment passing through plumbing by increasing a rate of pumping, as well as the step 242 of decreasing the rate of liquid treatment passing through plumbing by decreasing a rate of pumping. Further still, a seed treatment method may include the step 244 of discharging liquid treatment from plumbing in the seed treatment flow path. Additionally, a seed treatment method may include the step 246 of increasing dispensing of the discharged liquid treatment in the seed treatment flow path by increasing the rate of pumping, as well as the step 248 of increasing the dispersion of the discharged liquid treatment in the seed treatment flow path by increasing a rate of dispersion. As shown in FIG. 42, a seed treatment method may still further include the step 250 of decreasing the dispensing of the discharged liquid treatment in the seed treatment flow path by decreasing the rate of pumping, as well as the step 252 of decreasing the dispersion of the discharged liquid treatment in the seed treatment flow path by decreasing a rate of dispersion.

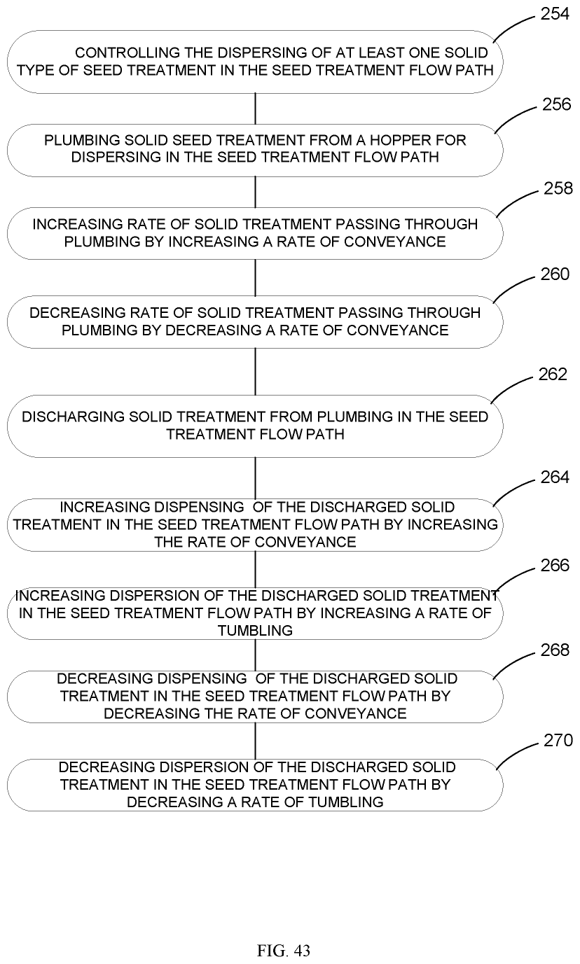

FIG. 43 shows another flowchart illustrating a seed treatment method in accordance with an illustrative aspect of the present disclosure. As shown, a seed treatment method may include the step 254 of controlling the dispersing of at least on solid type of seed treatment in the seed treatment flow path, and further include step 256 of plumbing solid seed treatment from a hopper for dispersing in the seed treatment flow path. A seed treatment method may also include the step 258 of increasing the rate of solid treatment passing through plumbing by increasing a rate of conveyance, and may also include the step 260 of decreasing the rate of solid treatment passing through plumbing by decreasing a rate of conveyance. Further still, a seed treatment method may include the step 262 of discharging solid treatment from plumbing in the seed treatment flow path. FIG. 43 further shows a seed treatment method may include the step 264 of increasing dispersion of the discharged solid treatment in the seed treatment flow path by increasing the rate of conveyance, and may also include the step 266 of increasing dispersion of the discharged solid treatment in the seed treatment flow path by increasing a rate of tumbling. Additionally, a seed treatment method may further include the step 268 of decreasing dispensing of the discharged solid treatment in the seed treatment flow path by decreasing the rate of conveyance, and my further include the step 270 of decreasing dispersion of the discharged solid treatment in the seed treatment flow path by decreasing a rate of tumbling.

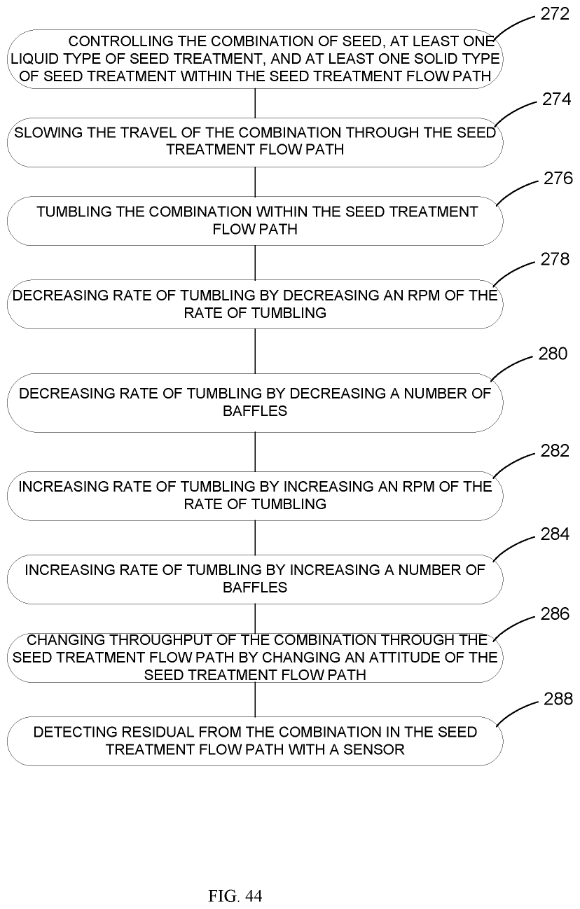

FIG. 44 shows another flowchart illustrating a seed treatment method in accordance with an illustrative aspect of the present disclosure. A seed treatment method may include the step 272 or controlling a combination of seed, at least one liquid type of seed treatment, and at least one solid type of seed treatment within a seed treatment flow path 12. A seed treatment method may further include the step 274 of slowing the travel of the combination through the seed treatment flow path 12. Further, a step 276 of tumbling the combination within the seed treatment flow path 12 may be included in a seed treatment method. Next, a step 278 of decreasing a rate of tumbling by decreasing an RPM of the rate of tumbling may be included in a seed treatment method and may further include the step 280 of decreasing a rate of tumbling be decreasing a number of baffles 104. A seed treatment method may also include the step 282 of increasing a rate of tumbling by increasing an RPM of the rate of tumbling, and may further include the step 284 of increasing a rate of tumbling by increasing a number of baffles 104. A step 286 of changing throughput of a combination through the seed treatment flow path 12 by changing an attitude of a seed treatment flow path 12 may be included in a seed treatment method. Finally, a step 288 of detecting residual from a combination in a seed treatment flow path 12 with a sensor may be included in a seed treatment method.

The seed treater 10 of the present disclosure includes, for example, a seed treatment flow path 12 configured to receive seed and seed treatment and discharge a combination of seed with seed treatment. A valve 36 may be positioned in the seed treatment flow path 12 for controlling seed movement. In at least one aspect, the valve 36 controls a throughput rate of seed introduced into the seed treatment flow path 12. A liquid disperser of the liquid seed treater system 50 may be disposed in the seed treatment flow path 12 for dispersing at least one liquid type of seed treatment at a liquid dispersion rate. In one aspect, the liquid disperser is disposed downstream of the valve 36. A solid disperser of the solid seed treater system 80 in the seed treatment flow path 12 may be disposed in the seed treatment flow path 12 for dispersing at least one solid type of seed treatment at a solid dispersion rate. In at least one aspect, the solid disperser is disposed downstream of the liquid disperser. An actuatable housing of the tumbling system 100 within the seed treatment flow path 12 has a rate of operation and an adjustable orientation. In at least one aspect, the actuatable housing is downstream of the valve 36 for uniformly distributing the at least one liquid type of seed treatment, the at least one solid type of seed treatment, and seed for creating the combination of seed with seed treatment. In at least one aspect, the adjustable orientation of the actuatable housing of the tumbling system 100 adjusts a rate of discharge of the combination of seed with seed treatment from the seed treatment flow path 12. In at least one other aspect, the rate of operation of the actuatable housing of the tumbling system 100 adjusts a rate of the uniform distribution of the at least one liquid type of seed treatment, the at least one solid type of seed treatment, and seed. In at least one additional aspect, the rate of operation of the actuatable housing of the tumbling system 100 is adjusted based on at least one of a type of seed, the at least one liquid type of seed treatment, the at least one solid type of seed treatment, the throughput rate of seed, the liquid dispersion rate, the solid dispersion rate, and the adjustable orientation of the tumbling system 100. In still another aspect, the throughput rate of seed may be adjusted based on at least one of a type of seed, the at least one liquid type of seed treatment of the liquid seed treater system 50, the at least one solid type of seed treatment of the solid seed treater system 80, the liquid dispersion rate of the liquid seed treater system 50, the solid dispersion rate of the solid seed treater system 80, the rate of operation of the actuatable housing of the tumbling system 100, and the adjustable orientation of the tumbling system 100. In yet another aspect, the solid dispersion rate of the solid seed treater system 80 may be adjusted based on at least one of a type of seed, the throughput rate of seed, the at least one liquid type of seed treatment of the liquid seed treater system 50, the at least one solid type of seed treatment of the solid seed treater system 80, the liquid dispersion rate of the liquid seed treater system 50, the rate of operation of the actuatable housing of the tumbling system 100, and the adjustable orientation of the tumbling system 100. In at least one other aspect, the liquid dispersion rate of the liquid seed treater system 50 may be adjusted based on at least one of a type of seed, the throughput rate of seed, the at least one liquid type of seed treatment of the liquid seed treater system 50, the at least one solid type of seed treatment of the solid seed treater system 80, the solid dispersion rate of the solid seed treater system 80, the rate of operation of the actuatable housing of the tumbling system 100, and the adjustable orientation of the tumbling system 100.

The seed treatment method of the present disclosure includes, for example, providing a seed treatment flow path 12 configured for receiving seed and seed treatment and discharging a combination of seed with seed treatment and a valve 36 having a gate 42 and gate opening 46. The method can include the steps of: controlling a throughput rate of seed into the seed treatment flow path 12 with a valve 36, wherein at least a portion of the gate 42 is disposed within the gate opening 46 in both open and closed positions 43; dispersing at least one liquid type of seed treatment of the liquid seed treater system 50 at a liquid dispersion rate into the seed treatment flow path 12 downstream of the valve 36; dispersing at least one solid type of seed treatment of the solid seed treater system 80 at a solid dispersion rate into the seed treatment flow path 12 downstream of the valve 36; and distributing the combination of seed, the at least one liquid type of seed treatment of the liquid seed treater system 50, and the at least one solid type of seed treatment of the solid seed treater system 80 at a rate of distribution of the tumbling system 100 within the seed treatment flow path 12. In at least one other aspect, adjusting a rate of discharge of the combination of seed with seed treatment from the seed treatment flow path 12 may be by adjusting the rate of the distribution of the tumbling system 100. In still another aspect, adjusting the rate of distribution of the seed of the tumbling system 100, the at least one liquid type of seed treatment of the liquid seed treater system 50, the at least one solid type of seed treatment of the solid seed treater system 80 by adjusting a rate of distributing the combination of seed of the tumbling system 100. In yet another aspect, adjusting the throughput rate of seed may be based on at least one of a type of seed, the at least one liquid type of seed treatment of the liquid seed treater system 50, the at least one solid type of seed treatment of the solid seed treater system 80, the liquid dispersion rate of the liquid seed treater system 50, the solid dispersion rate of the solid seed treater system 80, and the rate of distribution of the tumbling system 100. For another aspect, adjusting the rate of distribution of the tumbling system 100 may be based on at least one of a type of seed, the at least one liquid type of seed treatment of the liquid seed treater system 50, the at least one solid type of seed treatment of the solid seed treater system 80, the liquid dispersion rate of the liquid seed treater system 50, the solid dispersion rate of the solid seed treater system 80, and the throughput rate of seed.

The system for continuous treatment of seed of the present disclosure includes, for example, a seed treatment flow path 12 configured to receive seed and seed treatment and discharge a combination of seed with seed treatment. The system may include a valve 36 operably configured to introduce a continuous flow of seed into the seed treatment flow path 12 at a seed throughput rate. A liquid disperser of the liquid seed treater system 50 may be operably configured to introduce at least one liquid type of seed treatment into the seed treatment flow path 12 at a liquid dispersion rate. A solid disperser of the solid seed treater system 80 may be operably configured to introduce at least one solid type of seed treatment into the seed treatment flow path 12 at a solid dispersion rate. A controller 154 of the control system 150 may be operably configured to control the seed throughput rate, the liquid dispersion rate of the liquid seed treater system 50, and the solid dispersion rate of the solid seed treater system 80 based at least on one or more conditions selected at least from a type of seed and a type of seed treatment. A tumbler or drum 101 of tumbling system 100 may also be operably configured to assist in combining seed and seed treatment within the seed treatment flow path 12 at a tumbling rate, wherein the controller 154 is operably configured to control the tumbling rate 166 based at least on one or more conditions selected at least from the type of seed and the type of seed treatment. In at least one aspect, the at least one or more conditions are further selected at least from seed temperature, seed treatment flow path temperature, seed treatment flow path humidity, seed treater environment temperature, and seed treater environment humidity. A weighing system 180 may also be operably configured to weigh residual seed treatment remaining within the seed treatment flow path 12 from receiving seed and seed treatment and discharging a combination of seed with seed treatment. A tilt control system 140 may also be operably configured to control the orientation of the seed treatment flow path 12 for controlling a rate of discharge of the combination of seed with seed treatment from the seed treatment flow path 12. A pump 60 of the liquid seed treater system 50 may also be operably configured to peristaltically deliver the at least one liquid type of seed treatment to the liquid disperser of the liquid seed treater system 50 under operation of the controller 154 for changing the liquid dispersion rate of the liquid seed treater system 50. A linear actuator 39 may also be operably configured to actuate at least a portion of the gate 42 being disposed within a gate opening 46 in both open and closed positions 43 under operation of the controller 154 for controlling the seed throughput rate. A tilt control system 140 may also be operably configured to control the orientation of the seed treatment flow path 12 for controlling a rate of distribution of seed with seed treatment before discharge of the combination of seed with seed treatment from the seed treatment flow path 12.

The disclosure is not to be limited to the particular aspects described herein. In particular, the disclosure contemplates numerous variations in a continuous flow seed treater. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the disclosure. It is understood that any other modifications, substitutions, and/or additions can be made, which are within the intended spirit and scope of the disclosure.

What is claimed is:

1. A seed treater, comprising:
a seed treatment flow path configured to receive seed and seed treatment and discharge a combination of seed with seed treatment;
a valve in the seed treatment flow path for controlling seed movement, wherein the valve controls a throughput rate of seed introduced into the seed treatment flow path;
a liquid disperser in the seed treatment flow path for dispersing at least one liquid type of seed treatment at a liquid dispersion rate, wherein the liquid disperser is disposed downstream of the valve;
a solid disperser in the seed treatment flow path for dispersing at least one solid type of seed treatment at a solid dispersion rate, wherein the solid disperser is disposed downstream of the liquid disperser; and
an actuatable housing within the seed treatment flow path having a rate of operation and an adjustable orientation, wherein the actuatable housing is downstream of the valve for uniformly distributing the at least one liquid type of seed treatment, the at least one solid type of seed treatment, and seed for creating the combination of seed with seed treatment;
wherein the throughput rate of seed is based at least on one condition of the seed, the liquid dispersion rate is based on at least one condition of the liquid seed treatment, and the solid dispersion rate is based on at least one condition of the solid seed treatment.

2. The seed treater of claim 1, wherein the adjustable orientation of the actuatable housing adjusts a rate of discharge of the combination of seed with seed treatment from the seed treatment flow path.

3. The seed treater of claim 1, wherein the rate of operation of the actuatable housing adjusts a rate of the uniform distribution of the at least one liquid type of seed treatment, the at least one solid type of seed treatment, and seed.

4. The seed treater of claim 1, wherein the rate of operation of the actuatable housing is adjusted based on at least one of a type of seed, the at least one liquid type of seed treatment, the at least one solid type of seed treatment, the throughput rate of seed, the liquid dispersion rate, the solid dispersion rate, and the adjustable orientation.

5. The seed treater of claim 1, wherein the throughput rate of seed is adjusted based on at least one of a type of seed, the at least one liquid type of seed treatment, the at least one solid type of seed treatment, the liquid dispersion rate, the solid dispersion rate, the rate of operation of the actuatable housing, and the adjustable orientation.

6. The seed treater of claim 1, wherein the solid dispersion rate is adjusted based on at least one of a type of seed, the throughput rate of seed, the at least one liquid type of seed treatment, the at least one solid type of seed treatment, the liquid dispersion rate, the rate of operation of the actuatable housing, and the adjustable orientation.

7. The seed treater of claim 1, wherein the liquid dispersion rate is adjusted based on at least one of a type of seed, the throughput rate of seed, the at least one liquid type of seed treatment, the at least one solid type of seed treatment, the solid dispersion rate, the rate of operation of the actuatable housing, and the adjustable orientation.

8. A seed treatment method, comprising:
providing a seed treatment flow path configured for receiving seed and seed treatment and discharging a combination of seed with seed treatment and a valve having a gate and gate opening;
controlling a throughput rate of seed into the seed treatment flow path with a valve, wherein at least a portion of the gate is disposed within the gate opening in both open and closed positions;
dispersing at least one liquid type of seed treatment at a liquid dispersion rate into the seed treatment flow path downstream of the valve;
dispersing at least one solid type of seed treatment at a solid dispersion rate into the seed treatment flow path downstream of the valve; and
distributing the combination of seed, the at least one liquid type of seed treatment, and the at least one solid type of seed treatment at a rate of distribution within the seed treatment flow path, wherein the rate of distribution of the combination of seed, the at least one liquid type of seed treatment, and the at least one solid type of seed treatment is based on at least one condition of the combination of seed, at least one condition of the one liquid type of seed treatment, and at least one condition of the at least one solid type of seed treatment.

9. The seed treatment method of claim 8, further comprising:
adjusting a rate of discharge of the combination of seed with seed treatment from the seed treatment flow path by adjusting the rate of the distribution.

10. The seed treatment method of claim 8, further comprising:
adjusting the rate of distribution of the seed, the at least one liquid type of seed treatment, the at least one solid type of seed treatment by adjusting a rate of distributing the combination of seed.

11. The seed treatment method of claim 8, further comprising:
adjusting the throughput rate of seed based on at least one of a type of seed, the at least one liquid type of seed treatment, the at least one solid type of seed treatment, the liquid dispersion rate, the solid dispersion rate, and the rate of distribution.

12. The seed treatment method of claim 8, further comprising:
adjusting the rate of distribution based on at least one of a type of seed, the at least one liquid type of seed treatment, the at least one solid type of seed treatment, the liquid dispersion rate, the solid dispersion rate, and the throughput rate of seed.

13. A system for continuous treatment of seed, comprising:
a seed treatment flow path configured to receive seed and seed treatment and discharge a combination of seed with seed treatment;
a valve operably configured to introduce a continuous flow of seed into the seed treatment flow path at a seed throughput rate;
a liquid disperser operably configured to introduce at least one liquid type of seed treatment into the seed treatment flow path at a liquid dispersion rate;
a solid disperser operably configured to introduce at least one solid type of seed treatment into the seed treatment flow path at a solid dispersion rate; and
a controller operably configured to control the seed throughput rate, the liquid dispersion rate, and the solid dispersion rate based at least on one or more conditions of the seed, the liquid seed treatment, and of the solid seed treatment.

14. The system of claim 13, further comprising:
a tumbler operably configured to assist in combining seed and seed treatment within the seed treatment flow path at a tumbling rate, wherein the controller is operably configured to control the tumbling rate based at least on one or more conditions selected at least from the type of seed and the type of seed treatment.

15. The system of claim 13, wherein the at least one or more conditions are further selected at least from seed temperature, seed treatment flow path temperature, seed treatment flow path humidity, environment temperature, and environment humidity.

16. The system of claim 13, further comprising:
a weighing system operably configured to weigh residual seed treatment remaining within the seed treatment flow path from receiving seed and seed treatment and discharging a combination of seed with seed treatment.

17. The system of claim 13, further comprising:
a tilt control system operably configured to control the orientation of the seed treatment flow path for controlling a rate of discharge of the combination of seed with seed treatment from the seed treatment flow path.

18. The system of claim 13, further comprising:
a pump system operably configured to peristaltically deliver the at least one liquid type of seed treatment to the liquid disperser under operation of the controller for changing the liquid dispersion rate.

19. The system of claim 13, further comprising:
a linear actuator operably configured to actuate at least a portion of the gate being disposed within a gate opening in both open and closed positions under operation of the controller for controlling the seed throughput rate.

20. The system of claim 13, further comprising:
a tilt control system operably configured to control the orientation of the seed treatment flow path for controlling a rate of distribution of seed with seed treatment before discharge of the combination of seed with seed treatment from the seed treatment flow path.
